(19) United States
(12) Patent Application Publication
(10) Pub. No.: US 2025/0161849 A1
(43) Pub. Date: May 22, 2025

(54) AUTOMATED MEMBRANE CLEANING MODULE

(71) Applicant: Blue Origin, LLC, Kent, WA (US)

(72) Inventor: Gil Hurwitz, Bellevue, WA (US)

(21) Appl. No.: 18/512,562

(22) Filed: Nov. 17, 2023

(51) Int. Cl. B01D 41/00

(52) U.S. Cl. CPC B01D 41/00; B01D 2201/08; B01D 2321/04; B01D 2321/22; B01D 2321/40

(57) ABSTRACT

A system performs automatic cleaning of a membrane module that is used in a water treatment unit to remove impurities from water. The water treatment unit is part of a water purification system that also includes a membrane cleaning unit that is located remotely from the water treatment unit. While both are part of a water purification system, a membrane cleaning unit may be physically separated from a water treatment unit. Such separation of positioning and functionality may allow for parallel operations of water purification and membrane module cleaning.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for self-contained automated membrane module cleaning blocks. More specifically, the present disclosure relates to a system and a framework for determining and executing a self-contained membrane cleaning cycle.

### BACKGROUND

Membrane systems may be used to remove a variety of contaminants from water in a water purification process for treating crew cabin wastewater, such as in a space vehicle. Wastewater may include urine, hygiene water, and humidity condensate, just to name a few examples. Generally, membranes may be used to perform reverse osmosis, nanofiltration, ultrafiltration, microfiltration, forward osmosis, membrane distillation, and pervaporation. Unfortunately, membranes are known to lose performance over time due to the deposition of salts, organics, and biological material on the membrane surfaces. For this reason, unless they are replaced as determined by maintenance requirements, periodic membrane cleaning is generally necessary to recover desired performance, extend membrane lifetime, and maintain efficient water treatment system operation.

### SUMMARY

The systems, methods, and devices described herein each have several aspects, no single one of which is solely responsible for its desirable attributes. Without limiting the scope of this disclosure, several non-limiting features will now be discussed briefly.

Described herein is an improved self-contained membrane cleaning software that automatically determines a customized cleaning strategy including a sequence of cleaning cycles and intensity of cleaning cycles based on data collected during for example, normal membrane operation, forensic fouling analysis, and historical data. The self-contained membrane cleaning software can select cleaning cycles and sequences that will maximize membrane performance recovery while minimizing required cleaning resources. Use of the membrane cleaning software will ultimately result in maximized use for membrane material during crewed space-flight missions, eliminate the need for human intervention and/or operator training regarding membrane cleaning, and reduce the number of membranes required per flight.

In some aspects, the techniques described herein relate to a system for determining a cleaning strategy for a membrane module, the system including: memory that stores computer-executable instructions; and a processor in communication with the memory, where the computer-executable instructions, when executed by the processor, cause the processor to: process received operational sensor data and historical cleaning data, where the operational sensor data includes one or more characteristics of a water treatment unit, and where the historical cleaning data includes one or more characteristics of a membrane cleaning unit; determine, based on the processed operational data, one or more cleaning cycles for a membrane module; estimate, based on the determined one or more cleaning cycles and the historical cleaning data, a cleaning strategy, where the cleaning strategy includes a sequence of execution of at least one of the one or more cleaning cycles; and cause the membrane cleaning unit to execute the cleaning strategy to clean the membrane module.

In some aspects, the techniques described herein relate to a system, where the computer-executable instructions, when executed, further cause the processor to train an artificial intelligence model using training data to determine one or more cleaning strategies for the membrane module, where the training data comprises one or more training data items, where each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

In some aspects, the techniques described herein relate to a system, where the historical data further includes at least one of membrane module identification, a historical record of past cleaning strategies, or membrane module performance data based on previously executed cleaning strategies.

In some aspects, the techniques described herein relate to a system, where the computer-executable instructions, when executed, further cause the processor to determine one or more cleaning cycles for the membrane module based on forensic fouling analysis data.

In some aspects, the techniques described herein relate to a system, where the forensic fouling analysis data includes at least one of: organic fouling, biological fouling, metallic fouling, inorganic salt scaling, or colloidal particulate fouling data.

In some aspects, the techniques described herein relate to a system, where the operational sensor data further comprises at least one of a differential pressure measured across the membrane cleaning unit, a conductivity of the membrane module or process water, a turbidity of the process water, a flow rate of the process water, a current from one or more pumps of the water treatment unit, a discharge pressure from one or more pumps of the water treatment unit, or a detection of one or more chemicals in wastewater.

In some aspects, the techniques described herein relate to a system, where the computer-executable instructions, when executed, further cause the processor to determine an intensity for the one or more cleaning cycles, where the intensity of a cleaning cycle is associated with one of a duration of the cleaning cycle, a chemical composition of the cleaning cycle, or an energy level provided to one or more cleaning components of the membrane cleaning unit.

In some aspects, the techniques described herein relate to a system, where the one or more cleaning cycles include at least of a recirculation cycle, a physical dislodging cycle, a backwashing cycle, or an applied electric field cycle.

In some aspects, the techniques described herein relate to a system, where the recirculation cycle applies a chemical solution to the membrane module, where the physical dislodging cycle applies a physical force to the membrane module, where the backwashing cycle energizes one or more pumps of the membrane cleaning unit to reverse a flow of liquid through a membrane module, and where an applied electric field cycle applies an electric field to a membrane module to remove electrically-induced desorption of charged foulants.

In some aspects, the techniques described herein relate to a computer-implemented method for determining a cleaning strategy for a membrane module, the computer-implemented method including: receiving operational sensor data and historical cleaning data, where the operational sensor data includes one or more characteristics of a water treatment unit, and where the historical cleaning data includes one or more characteristics of a membrane cleaning unit; determining, based on the operational data, one or more cleaning cycles for a membrane module; estimating, based on the determined one or more cleaning cycles and the historical cleaning data, a cleaning strategy, where the cleaning strategy includes a sequence of execution of at least one of the one or more cleaning cycles; and causing the membrane cleaning unit to execute the cleaning strategy to clean the membrane module.

In some aspects, the techniques described herein relate to a computer-implemented method, further including training an artificial intelligence model using training data to determine one or more cleaning strategies for the membrane module, wherein the training data comprises one or more training data items, where each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

In some aspects, the techniques described herein relate to a computer-implemented method, where the historical data further includes at least one of membrane module identification, a historical record of past cleaning strategies, or membrane module performance data based on previously executed cleaning strategies.

In some aspects, the techniques described herein relate to a computer-implemented method, where determining one or more cleaning cycles further includes determining one or more cleaning cycles for the membrane module based on forensic fouling analysis data.

In some aspects, the techniques described herein relate to a computer-implemented method, where the forensic fouling analysis data includes at least one of: organic fouling, biological fouling, metallic fouling, inorganic salt scaling, or colloidal particulate fouling data.

In some aspects, the techniques described herein relate to a computer-implemented method, where the operational sensor data further comprises at least one of a differential pressure measured across the membrane cleaning unit, a conductivity of the membrane module or process water, a turbidity of the process water, a flow rate of the process water, a current from one or more pumps of the water treatment unit, a discharge pressure from one or more pumps of the water treatment unit, or a detection of one or more chemicals in wastewater.

In some aspects, the techniques described herein relate to a computer-implemented method, further including determining an intensity for the one or more cleaning cycles, where the intensity of a cleaning cycle in the one or more cleaning cycles is associated with one of a duration of the cleaning cycle, a chemical composition of the cleaning cycle, or an energy level provided to one or more cleaning components of the membrane cleaning unit.

In some aspects, the techniques described herein relate to a non-transitory, computer-readable medium including computer-executable instructions for determining a cleaning strategy for a membrane module, where the computer-executable instructions, when executed by a computer system, cause the computer system to: process received operational sensor data and historical cleaning data, where the operational sensor data includes one or more characteristics of a water treatment unit, and where the historical cleaning data includes one or more characteristics of a membrane cleaning unit; determine, based on the processed operational data, one or more cleaning cycles for a membrane module; estimate, based on the determined one or more cleaning cycles and the historical cleaning data, a cleaning strategy, where the cleaning strategy comprises a sequence of execution of at least one of the one or more cleaning cycle; and cause the membrane cleaning unit to execute the cleaning strategy to clean the membrane module.

In some aspects, the techniques described herein relate to a non-transitory, computer-readable medium, where the computer-executable instructions, when executed, further cause the computer system to train an artificial intelligence model using training data to determine one or more cleaning strategies for the membrane module, wherein the training data comprises one or more training data items, wherein each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

In some aspects, the techniques described herein relate to a non-transitory, computer-readable medium, where the historical data further includes at least one of membrane module identification, a historical record of past cleaning strategies, or membrane module performance data based on previously executed cleaning strategies.

In some aspects, the techniques described herein relate to a non-transitory, computer-readable medium, where the computer-executable instructions, when executed, further cause the computer system to determine one or more cleaning cycles for the membrane module based on forensic fouling analysis data.

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that include one or more computer-readable storage mediums having program instructions embodied therewith, and one or more processors configured to execute the program instructions to cause the systems and/or computer systems to perform operations comprising one or more aspects of the above-and/or below-described implementations (including one or more aspects of the appended claims).

In various implementations, computer-implemented methods are disclosed in which, by one or more processors executing program instructions, one or more aspects of the above-and/or below-described implementations (including one or more aspects of the appended claims) are implemented and/or performed.

In various implementations, computer program products comprising one or more computer-readable storage mediums are disclosed, where the computer-readable storage mediums have program instructions embodied therewith, the program instructions executable by one or more processors to cause the one or more processors to perform operations comprising one or more aspects of the above-and/or below-described implementations (including one or more aspects of the appended claims).

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of an example water purification system that includes an automated membrane cleaning unit, according to some embodiments.

FIG. 2 is a block diagram of an example water treatment unit, according to some embodiments.

FIG. 3 is a block diagram of an example membrane cleaning unit, according to some embodiments.

FIG. 4 is a block diagram illustrating communication between a water treatment unit and a membrane cleaning unit, according to some embodiments.

FIG. 5 is a flow diagram of a process for cleaning a membrane module, according to some embodiments.

FIG. 6 is a block is a block diagram of an example water treatment system.

FIG. 7 is a block diagram of an illustrative operating environment in which a water treatment system uses data to determine an optimized cleaning strategy.

FIG. 8 is a flow diagram illustrating the operations performed by the components of the operating environment of FIG. 7 to determine an optimized membrane module cleaning strategy.

FIG. 9 is a flow diagram illustrating the operations performed by the components of the operating environment of FIG. 7 to train an AI model to determine an optimized cleaning strategy.

FIG. 10 is a flow diagram depicting an example membrane cleaning strategy selector routine.

FIG. 11 is a block diagram of an example computer system consistent with various implementations of the present disclosure.

### DETAILED DESCRIPTION

One of the most pressing challenges for spacecraft manufacturers is the need for clean potable water. As space mission objectives become more ambitious, the systems and methods employed to produce clean drinking water can become critical factors for determining mission length and overall success. Additionally, carrying excessive water during launch can increase weight of the spacecraft and result in excess consumption of propellant. Thus, to increase space mission durations and reduce propellant consumption and/or other operational costs, spacecraft manufacturers aim to limit the amount of water carried during each launch.

One way to limit the amount of water carried during launch is to recycle some of the water consumed by the cabin and crew. A spacecraft may recycle cabin and crew water when equipped with a water purification system. A water purification system employs several cleaning techniques to transform water that would otherwise flow down a drain on Earth, into recycled, clean drinking water. A water purification system can recycle liquid (e.g., water) from various sources, such as urine, sweat, and even ambient air humidity. A water purification system may use several techniques for cleaning wastewater, such as applying an electric current to the wastewater, adjusting the temperature or pressure of the wastewater to promote evaporation, running the wastewater through selective adsorptive media, running the water through a filter, or the like. One technique for cleaning wastewater utilizes a membrane developed from, for example, dense polymeric materials with high permeability of water over dissolved and particulate impurities. The membrane can be used to perform several cleaning tasks, such as reverse osmosis, nanofiltration, ultrafiltration, microfiltration or the like. Over time, deposits on the surface of a membrane, such as salts, organics, biological materials, and the like, can degrade membrane performance. Eventually, the performance of a membrane within the water purification system will degrade to the point where the membrane must be taken off-line and cleaned, and/or or replaced altogether.

Conventional methods of removing and cleaning a membrane can reduce crewmember efficiency, add costs to overall mission objectives, and introduce added risk to cabin and crew alike. For example, when crew members undertake maintenance tasks such as cleaning a membrane, the limited crew resources are simultaneously taken away from performing mission objectives, such as scientific research, spacecraft navigation, other spacecraft maintenance, and/or the like. Hence, allocating resources to maintenance tasks ultimately reduces the usefulness of the crew and potential profitability of the mission. Moreover, crewmembers tasked with cleaning a membrane must be thoroughly trained on the standard operating procedures for membrane cleaning. In order for a crewmember to clean a membrane, the crewmember must undergo lengthy and expensive training, requiring that the crewmember demonstrate they have the technical knowledge, skills, and training to efficiently remove and clean a membrane module. Thus, the necessity to train crewmembers on membrane cleaning increases costs, workload demands, the minimum technical competency required of the crewmembers aboard a spacecraft, and/or the likelihood that the completion of other mission objectives is delayed.

Cleaning a membrane module poses a safety risk to the crew and a mission when a trained crewmember cleans a membrane, and the water purification system must be taken off-line for the duration of the cleaning. Even with a skilled crewmember, membrane cleaning can be a lengthy and time-consuming process. Prolonged downtime of the water purification system poses a safety risk to the crew during a space mission, as the water purification system is a necessary life-support system. Along with the safety risk to the crew posed by deenergizing the water purification system, the membrane cleaning process introduces additional safety risks to the cabin and crew because the membrane cleaning process requires the handling of toxic materials. If an accident were to occur during membrane cleaning, the cabin and crew can potentially be exposed to toxic chemicals. Consequently, as the number of membrane cleanings increase, so does the risk of accident and exposure during missions.

In addition to the problems disclosed above, conventional membrane cleaning methods can limit the length of spacecraft missions. For example, even though membranes can be cleaned and reused during longer-duration missions, eventually the membranes will require replacement. Replacement membranes along with consumables used to clean membranes (herein after cleaning resources) must be stored in the spacecraft during launch and for the duration of the mission, increasing the total cost of launch and requiring additional storage space onboard a spacecraft. Missions may be limited in their duration as the spacecraft may not have enough storage space allocated for membranes and/or cleaning resources to support a desired mission length, requiring costly spacecraft redesign and/or increased launch costs.

Further, anticipating the useful life of a membrane may be difficult when crewmembers manually clean membranes. This uncertainty can result in ultra-conservative and sometimes inaccurate estimations for membrane usefulness. The crew may not have access to the necessary data to competently determine an optimized cleaning strategy. Thus, membrane performance may degrade rapidly, inconsistently, and/or be compromised when an inadequate or incorrect cleaning strategy is applied to the membrane.

To reduce the number of membrane replacements and cleanings performed by crewmembers, a membrane cleaning unit may be added to the water purification system. A conventional membrane cleaning unit can prolong membrane operational life by performing one or more cleaning tasks typically performed by a crewmember. The membrane module can be connected in parallel to the water treatment unit such that little or no downtime is experienced during membrane cleaning cycles. The conventional membrane cleaning unit can perform a multitude of various chemical and/or physical cleaning cycles on a membrane.

However, conventional membrane cleaning units are unable to select and execute the most effective and/or efficient cleaning strategies (e.g., a sequence of cleaning cycles) to optimize the lifecycle of a membrane. For example, each cleaning cycle performed by a conventional membrane cleaning unit specifically targets select particulate(s), not all possible particulate(s) that may be present on the membrane. In addition, even if a cleaning cycle is executed that is designed to specifically target removal of a particular particulate, the cleaning cycle may be less effective if, for example, another type of cleaning cycle was not previously run. Understanding the types of particulates present on the membrane, the cleaning cycles that must be applied to effectively clean a membrane having specific types of particulates, and/or determining an efficient strategy (e.g., an efficient sequence of execution of cleaning cycles) to increase the operational lifecycle of a membrane is difficult, and conventional membrane cleaning units lack any specific hardware and/or software that would allow such membrane cleaning units to determine the specific types of particulates present on the membrane, cleaning cycles that would be best for removing the particulates, and/or the sequence in which the cleaning cycles should be executed to achieve optimal particulate removal.

Thus, determining an efficient membrane cleaning strategy can extend the usefulness of a membrane, providing a multitude of advantages to crewmembers and spacecraft manufacturers alike. Advantages include the ability to set and achieve more ambitious mission objectives by reducing ministerial tasks assigned to the crew, minimizing operational costs both during launch and throughout a mission by reducing the quantity of membranes stored on the spacecraft for a mission, and reducing risk to cabin and crew by eliminating downtime of vital environmental control and life support systems.

This disclosure describes architectures and methods for automatic cleaning of a membrane module that is used in a water treatment unit to remove impurities from water. The water treatment unit is part of a water purification system that also includes a membrane cleaning unit that is located remotely from the water treatment unit. In other words, while both are part of a water purification system, a membrane cleaning unit may be physically separated from a water treatment unit. Such separation of positioning and functionality may allow for parallel operations of water purification and membrane module cleaning. This contrasts with a system that uses some of the same parts of the system to both purify water and to clean the membrane module. In this case, the water purification process would be halted until the membrane module cleaning process is completed. Thus, an advantage of embodiments of systems described herein is that membrane cleaning may be performed with substantially no downtime of a water purification process.

Another advantage of embodiments described herein is that the membrane module cleaning process is automatic, where human interaction with the process need not occur. For example, some embodiments include a stand-alone membrane cleaning unit configured to automatically clean used membrane modules for reuse in the water treatment unit. The membrane cleaning unit may be compatible with membrane modules having standardized interfaces so that they may be easily installed into, and removed from, the water treatment unit and placed into the separate membrane cleaning unit, for which such installation and removal of a membrane module is also compatible and easy. Chemical and/or physical cleaning of the membrane module may occur automatically in the membrane cleaning unit, which may be controlled by a computer processer that can automatically customize a cleaning sequence based on data collected during membrane operation in the water treatment unit. The cleaning sequence may also be based on forensic fouling analysis, and historical cleaning performance. Such customized cleaning sequences may use cleaning strategies that will maximize membrane performance recovery while minimizing required cleaning resources.

The accumulation of rejected material (e.g., impurity material that is filtered out from water) on a membrane surface is generally the most important operational factor influencing performance and lifetime of the membrane purification system. Without automation, as described herein, membrane cleaning is a laborious and time-consuming process typically performed by a trained operator. Such a manual cleaning process may be unacceptable within a standard crewed spacecraft environment because of the lack of technical expertise (e.g., among the crew), the inability for any component of the water purification system to be offline for an extended period of time, and the handling of potentially toxic fluids. Embodiments described herein may alleviate these issues by providing a self-contained membrane cleaning system for relatively easy and highly automated membrane module cycling without the need for experienced technologists or operators, for example.

In some embodiments, a membrane module cleaning system may comprise a water treatment unit to purify water and a membrane cleaning unit to clean the membrane module. The water treatment unit may include a water treatment chamber to hold and use a membrane module, one or more sensors to measure parameters of the water treatment unit (e.g., operating pressure of a pump, water temperature, water acidity levels, etc.), electronic memory to store the parameters of the water treatment unit, and a transmitter configured to transmit, among other things, the parameters of the water treatment unit. The water treatment chamber may be a space within the water treatment unit configured to receive a membrane module for the water purification process. Water to be purified flows into the water treatment chamber, through the membrane module, and the resulting purified water flows out of the water treatment chamber.

The set of sensors may measure various parameters of the water treatment unit. For example, the set of sensors may include pressure sensors, flow gauges, electrical conductivity sensors, image sensors, temperature sensors, and turbidity sensors, just to name a few examples. Any of these sensors may be located on the input and/or output side of the membrane module.

The electronic memory of the water treatment unit may be configured to receive and store data measured by the set of sensors. Such data may be time-stamped based on a system clock. The transmitter (e.g., or a transceiver) may be configured to transmit the stored data, or transmit parameters of the water treatment unit that are not stored, to the membrane cleaning unit.

The membrane cleaning unit, which may be located remotely from the water treatment unit, may include a cleaning chamber configured to hold and clean the membrane module, a set of sensors to measure parameters of the membrane module, and a receiver to receive, from the transmitter of the water treatment unit, the parameters of the water treatment unit. The set of sensors may include electrical conductivity sensors and image sensors, just to name a few examples. Any of these sensors may be located on the input and/or output side of the membrane module. The membrane cleaning unit may also include electronic memory for storing a history that includes cleaning processes previously applied to the membrane module and results of the cleaning processes. The membrane cleaning unit may also include a processor that is configured to automatically clean the membrane module based on the parameters of the membrane module, the parameters of the water treatment unit, and the history.

In some implementations, the processor of the membrane module cleaning system may be configured to automatically clean the membrane module by controlling pumps to recirculate a cleaning fluid, which may be heated, that is applied to the membrane module. The processor of the membrane module cleaning system may also be configured to automatically clean the membrane module by controlling an application of ultrasonication or aeration of a cleaning solution to the membrane module. The processor of the membrane module cleaning system may be configured to automatically clean the membrane module by controlling an application of vibratory shear on the membrane module, by controlling a process of backwashing of the membrane module, and/or by applying an electric field for electricity-induced desorption of charged foulants on the membrane module, just to name a few examples.

In some embodiments, a method of cleaning a membrane module may include receiving parameters of the water treatment unit (including of water that previously flowed through the membrane module), measuring parameters of the membrane module, and retrieving, from electronic memory, a history that includes cleaning processes previously applied to the membrane module and results of the cleaning processes. The method further includes automatically cleaning the membrane module based on the parameters of the membrane module, the parameters of the water treatment unit, and the history. The parameters of the water treatment unit that previously flowed through the membrane module may be received from a remote water treatment unit, for example. Some of the parameters of the water treatment unit may include flow rate and some of the parameters of the membrane module may include image characteristics (e.g., of a captured image) of a surface of the membrane module.

In some implementations, a water treatment system can be included as part of a spacecraft, designed to recycle cabin and crew wastewater into potable water. A water treatment system can include crew and cabin wastewater, a water treatment unit, and a membrane cleaning unit. Wastewater from the cabin and crew can be transferred, via one or more pumps, to the water treatment unit where the wastewater is filtered by a membrane module. After filtration, the purified water is reused within the crewed environment, where it can be transferred via one or more pumps back to various parts of the spacecraft. During operation, a membrane module may accumulate salts, organics, and biological material on its surface. One or more sensors can be used to determine whether the membrane module requires cleaning and/or whether the membrane module is degraded to the point it must be replaced. Further, one or more sensors can be used to determine a cleaning strategy, including on one or more cleaning cycles to improve the performance and longevity of a membrane module.

To clean a membrane module, the membrane module can be transferred to a membrane cleaning unit. The membrane cleaning unit can be located adjacent to, or near the water treatment unit. Transfer can occur automatically and/or manually. At the membrane cleaning unit, a controller may determine and execute a sequence of cleaning strategies as described herein, to maximize the performance and reliability of the membrane module. A cleaning strategy can be determined based on, for example, historical data, operational data, forensic fouling analysis and/or the like.

For example, disclosed herein is a system and methods for determining a membrane cleaning strategy. The membrane cleaning strategy can automatically apply a customized cleaning sequence and determine an intensity of cleaning cycles based on data collected during normal membrane operation, forensic fouling analysis, and historical data. The membrane cleaning strategy may increase membrane usage and efficiency by, for example, selecting a sequence of cleaning cycles that will maximize membrane performance recovery while minimizing required cleaning resources.

Each cleaning cycle determined as part of a cleaning strategy can be performed automatically based on a command from, for example a controller. The membrane cleaning unit may perform one or more sequences of different cleaning cycles. A few examples of cleaning cycles can include, but are not limited to, a recirculation cycle, a physical dislodging cycle, a backwashing cycle, an applied electric field cycle, and/or the like. Each cleaning cycle can be effective at removing inorganic scale (e.g., carbonate and phosphate salts), organic fouling with low adhesive forces (e.g., organic acids), biological fouling (e.g., polysaccharides), and/or colloidal/particulate deposits. The basic functionality and control structure for determining a cleaning strategy will be described herein with reference to one or more figures.

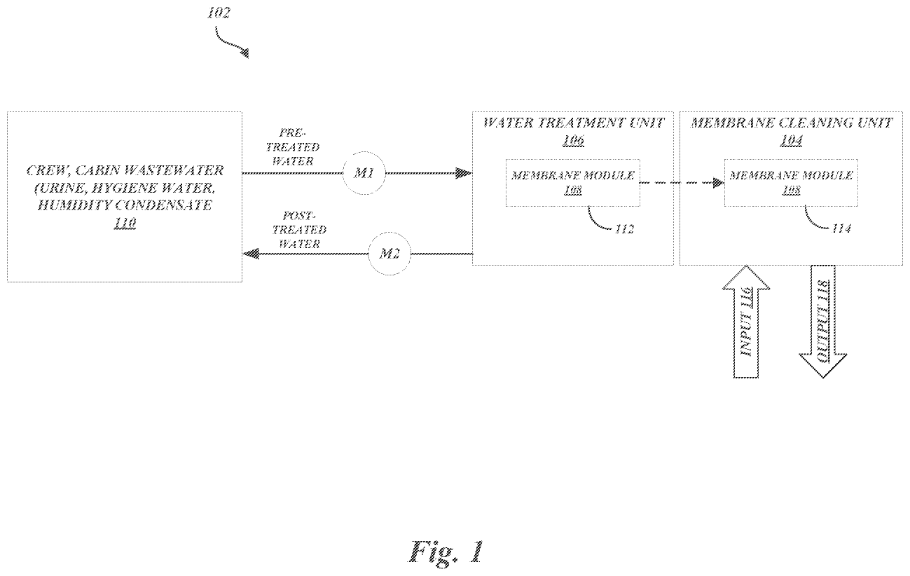

FIG. 1 is a block diagram of a water purification system 102 that includes an automated membrane cleaning unit 104, according to some embodiments. A water treatment unit 106 is configured with a membrane module 108 to remove impurities from water. The impure water may be received from a cabin 110 or other crew environment that produces wastewater. In a general process, pre-treated water from cabin 110 may be pumped to water treatment unit 106. Membrane module 108 filters out substantially all impurities in the pre-treated water and thus produces purified water that is provided back to cabin 110 as potable water after final water polishing, if needed. Water treatment unit 106 may include a water treatment chamber 112, which may be an open volume that accommodates membrane module 108. Pre-treated water flows into one portion of water treatment chamber 112, on one side (e.g., the input side) of membrane module 108, and treated water flows into another portion of the water treatment chamber, on the opposite, or output, side of membrane module 108. Various sensors, collectively and schematically represented in the figure by M1 and M2, such as pressure sensors, flow gauges, electrical conductivity sensors, image sensors, temperature sensors, and turbidity sensors, may be located in water treatment unit 106 in either portion of the water treatment chamber or in other parts of the water treatment unit. Accordingly, sensors M1, being on an input side of membrane module 108, can measure parameters of the pre-treated water while sensors M2, being on the output side of the membrane module, can measure parameters of the post-treated water. Delta values, such as membrane-caused differences in water pressure or turbidity, may thus be measured.

Membrane cleaning unit 104, which may be located remotely from water treatment unit 106, may include a cleaning chamber 114 to hold and clean membrane module 108. After a period of usage in water treatment unit 106, the membrane module may become fouled (e.g., clogged) with impurities that it removed from the pre-treated water. This condition of the membrane module may prompt an operator (or an automatic robotic end effector in some implementations) to remove the membrane module from the water treatment unit and place the membrane module into cleaning chamber 114 of membrane cleaning unit 104, where it may be cleaned and readied to replace back into water treatment unit 106.

Membrane cleaning unit 104 may clean membrane module 108 after receiving parameters, such as flow rate or turbidity, of the pre-treated and/or post-treated water that previously flowed through the membrane module when it was in water treatment unit 106. Membrane cleaning unit 104 may include various sensors (e.g., an image sensor) that measure parameters of the membrane module, such as image characteristics of a surface of the membrane module, a change in electrical conductivity of a conductive membrane module, and/or the like. Membrane cleaning unit 104 may also include an electronic memory that stores a history that includes cleaning processes previously applied to the membrane module and results of the cleaning processes. For example, cleaning processes may include sequences of various cleaning techniques, how long each cleaning technique was applied, and/or a cleaning intensity (e.g., an indication of a concentration of one or more chemicals used during a cleaning technique). Based on the parameters of the membrane module, the parameters of the water from the water treatment unit, and the history retrieved from memory, membrane cleaning unit 104 may automatically clean the membrane module that is placed in cleaning chamber 114.

Membrane cleaning unit 104 may be connected to various fluid and chemical supplies via input 116. For example, the fluids and chemicals, which may be used for various cleaning methods, may include water, acids, surfactants, aerated solutions, chelating agents, and caustic chemicals, just to name a few examples. Relatively small pumps may be used to provide the supplies to input 116. Output 118 may comprise various drain tubes to carry post-cleaning waste solutions from membrane cleaning unit 104. Relatively small pumps may be used to pull the waste solutions via output 118.

Optionally, the membrane cleaning unit 104 can analyze the waste solutions to be output via output 118 to determine whether a portion of the waste solutions can be reused. If the membrane cleaning unit 104 determines that a portion of the waste solutions can be reused or recycled, the membrane cleaning unit 104 can either separate that portion of the waste solutions so that that portion is not pulled by the relatively small pumps or the membrane cleaning unit 104 can direct a different set of pumps to pull that portion of the waste solutions. The membrane cleaning unit 104 or another component (not shown) may then filter, sanitize, or otherwise clean the portion of the waste solutions that the membrane cleaning unit 104 determines can be reused to form a recycled version of the waste solutions for use in future cleanings. For the portion of the waste solutions that the membrane cleaning unit 104 determines cannot be reused, that portion may be discarded (e.g., via the relatively small pumps and output 118).

Automatic cleaning performed by membrane cleaning unit 104 may involve various sequences of different types of cleaning processes. For example, one cleaning process is a recirculation of a cleaning fluid, which may be heated. In some implementations, an acidic chemical solution, such as hydrochloric acid and/or citric acid, may be used to remove inorganic salt scale. In other implementations, a caustic chemical solution, which may be heated, may be used to remove organic fouling. The caustic chemical solution may include an oxidizing agent such as hydrogen peroxide, ozone, or chlorine, for example. In other implementations, a chelating agent, such as EDTA, may be used to remove adsorbed metals and divalent cations. In still other implementations, a surfactant, such as sodium dodecyl sulfate, may be used to remove organic macromolecules.

Another cleaning process involves physical dislodging of fouling agents. In some implementations, ultrasonication with a recirculating fluid may be used for such physical dislodging. The recirculating fluid may involve alternating low-pressure and high-pressure waves in the fluid, leading to the formation and violent collapse of small bubbles. In other implementations, vibratory shear on the membrane module (e.g., physical vibration of the membrane) may be used for physical dislodging of the fouling agents. In still other implementations, an aerated solution for microbubble and nanobubble surface scouring may be used for physical dislodging.

Another cleaning process involves backwashing. In some implementations, reverse flow and pulsed backwashing may push fluids through the membrane to help dislodge fouling agents. Osmotic backflushing that creates a reverse concentration gradient may also be useful for cleaning.

Still another cleaning process involves applying an electric field for electricity-induced desorption of charged foulants. In some implementations, the electric field may be applied directly to conductive membranes. Otherwise, for nonconductive membranes, the electric field may be applied via one or more electrodes. In other implementations, an applied electric field may lead to reactive species generation, such as hydroxyl radicals, by electrically-active particles, such as TiO2, within the membrane film.

Such cleaning methods may be effective at removing simple scales (e.g., carbonate and phosphate salts) and organic fouling having relatively low adhesive forces. Other cleaning methods may be used against more aggressive scaling, such as sulfate salts and silica, and hard-to-remove foulants, such as biopolymers and polysaccharides. Claimed subject matter is not limited to any particular type, or combination, of cleaning methods.

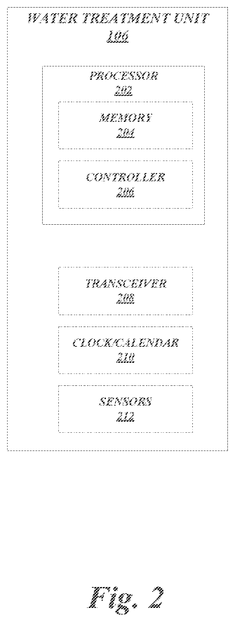

FIG. 2 is a block diagram of water treatment unit 106, according to some embodiments. The water treatment unit includes a processor 202, electronic memory 204, and a controller 206, which may be integrated with the processor. Details of processor 202 are described below. Water treatment unit 106 further includes a transceiver 208, which may be wired or wireless, a clock/calendar 210, and sensors 212. Processor 202 may manage collection of data collected by sensors 212 and may operate transceiver 208 to transmit the data to membrane cleaning unit 104. The processor may also, in some implementations, use sensor data to determine if the membrane module is performing relatively poorly and may provide a notification of such a condition to an operator, who may resultantly remove the membrane module to be cleaned in the membrane cleaning unit.

Sensor data may be time-stamped based on clock/calendar 210. Time-stamped data, which may be stored in memory 204 and may be transmitted to membrane cleaning unit 104, can be useful for a process of determining a history of performance of the membrane module. Such a determination process may be performed by processor 202 or by a processor (e.g., 302) in the membrane cleaning unit. For example, history of performance may include how many times a particular membrane module has been cleaned, durations between consecutive cleanings, and cleaning efficiency as a function of time. In some implementations, cleaning efficiency may be a function of a pressure difference (delta) between input and output sides of the membrane module over time (for a fixed value of purification). For example, as the membrane module becomes increasingly fouled, the pressure delta may increase. Conversely, an increase in pressure delta may indicate an increase, which may be quantified, in membrane fouling.

History of performance may also include information regarding environmental details, such as crew size, physiological details of the crew (e.g., which may affect urine composition), and number of water treatment units operating concurrently, just to list a few examples.

Sensors 212 may include a flow gauge to measure water flow rate. Sensors may also include one or more pressure sensors, located on either or both sides of the membrane module to measure pressure drop across the membrane module. As explained above, pressure drop may be indicative of an amount of membrane fouling. In some implementations, sensors 212 may also be configured to measure electrical conductivity, which may be indicative of salt or ionic concentrations. In still other implementations, sensors 212 may measure turbidity using optical (e.g., emitter-detector pair) sensors. A difference in turbidity before and after the membrane module may be indicative of how well the membrane module is cleaning the pre-treated water, and thus whether the membrane module is substantially fouled and in need of cleaning.

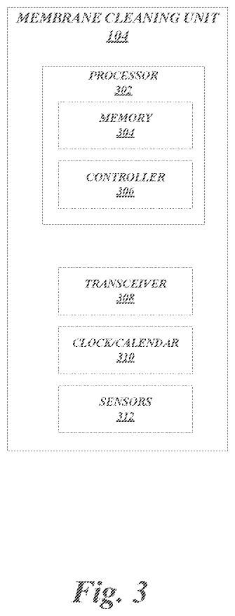

FIG. 3 is a block diagram of membrane cleaning unit 104, according to some embodiments. The membrane cleaning unit includes a processor 302, electronic memory 304, and a controller 306, which may be integrated with the processor. Details of processor 302 are described below. Membrane cleaning unit 104 may further include a transceiver 308, which may be wired or wireless, a clock 310/calendar 210, and sensors 312. Processor 302 may manage collection of data collected by sensors 312 as well as data received, via transceiver 308, from water treatment unit 106. Sensors 312 may include one or more electrical conductivity probes to measure conductivity of a membrane module that is installed in cleaning chamber 114, for example. Thus, electrical conductivity may be among other parameters of the membrane module used to determine types or quantity of fouling of the membrane module. Other parameters of the membrane module may include one or more image sensors to capture images of the membrane module surface. Characteristics of the surface, such as roughness, color, and texture, for example, may be used to determine the types of fouling agents and/or their quantities on membrane module surfaces. In some implementations, processor 302 may perform image analysis (e.g., pattern recognition or image matching) by comparing historical or reference images stored in memory 304 to current images of the membrane module surfaces. Such image analysis may lead to a determination of fouling agent details and the best way to remove such fouling agents from the membrane module. Among other things, memory 304 may also store a history that includes, in some examples, historical or reference images, cleaning processes previously applied to the membrane module, and results of these cleaning processes.

Processor 302 may determine cleaning procedures appropriate for the type and level of membrane fouling. For example, the processor 302 may automatically customize a cleaning sequence based on data collected during membrane operation in water treatment unit 106. The cleaning sequence may also be based on forensic fouling analysis (e.g., as measured by sensors 312, such as sensors 312 that can identify majority organic fouling, majority biological fouling, majority metallic fouling, majority inorganic salt scaling, majority colloidal particulate fouling and/or cake formation, etc.), and historical cleaning performance (e.g., as stored in memory 304). Such customized cleaning sequences may use cleaning strategies that will maximize membrane performance recovery while minimizing required cleaning resources. In some implementations, processor 302 may be configured to automatically clean the membrane module by controlling pumps to circulate or recirculate various cleaning solutions, which may be heated, and apply them to the membrane module. The processor may also be configured to automatically clean the membrane module by controlling an application of ultrasonication or aeration of a cleaning solution to the membrane module. The processor may also be configured to automatically clean the membrane module by controlling an application of vibratory shear on the membrane module, by controlling a process of backwashing of the membrane module, and/or by applying an electric field for electricity-induced desorption of charged foulants on the membrane module, just to name a few examples.

In some implementations, processors 202 and 302 may be a single processor located within, or outside of, water purification system 102. Such a single processor may implement processes via wireless communications with various transducers and electronics, for example, located in water treatment unit 106 or membrane cleaning unit 104. In some implementations, memory 204 and memory 304 may be a single memory located within, or outside of, water purification system 102. Similarly, clock/calendar 210 and clock 310 may be a single time-keeping entity located within, or outside of, water purification system 102.

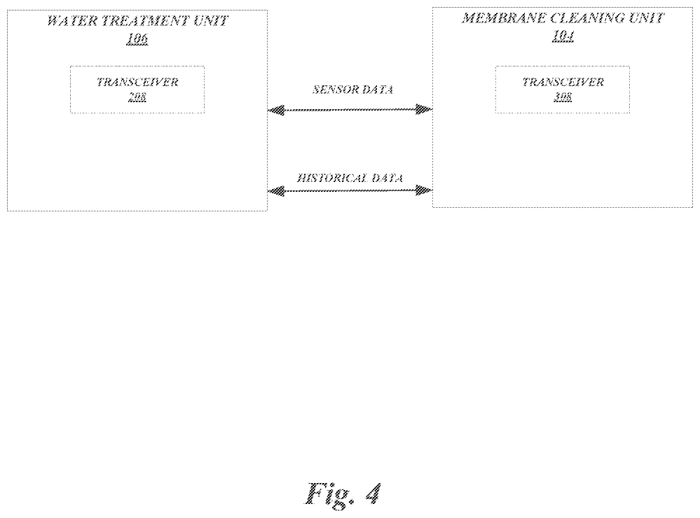

FIG. 4 is a block diagram illustrating communication, which may be wired or wireless, between water treatment unit 106 and membrane cleaning unit 104, according to some embodiments. As discussed above, sensor data measured in water treatment unit 106 may be transmitted by water treatment unit 106 to membrane cleaning unit 104, and can be useful for a process of determining a history of performance of the membrane module. Also, information regarding history of performance of the membrane module, as determined by water treatment unit 106, may be transmitted by water treatment unit 106 to membrane cleaning unit 104. Conversely, sensor data measured in membrane cleaning unit 104 may be transmitted by the membrane cleaning unit to water treatment unit 106. Also, information regarding a history that includes cleaning processes previously applied to a membrane module and results of the cleaning processes, as determined by membrane cleaning unit 104, may be transmitted by the membrane cleaning unit to the water treatment unit 106.

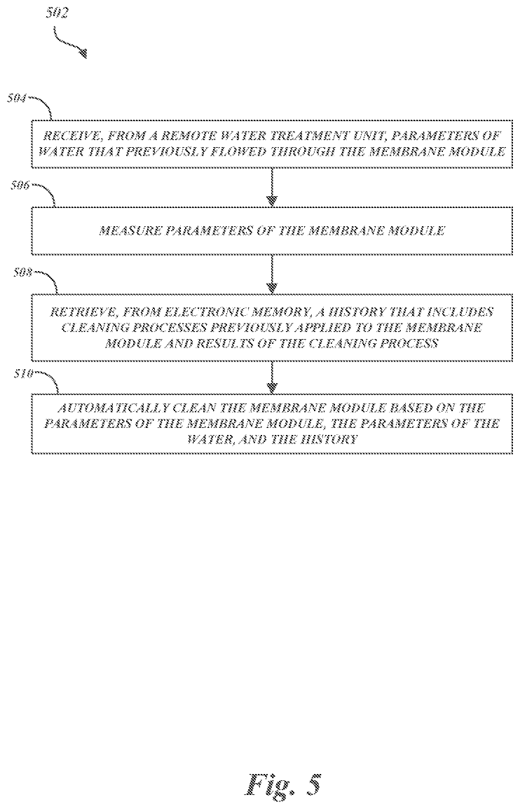

FIG. 5 is a flow diagram of a process 502 for cleaning a membrane module, such as 108, according to some embodiments. Process 502 may be performed automatically by a processor, which may be located anywhere in water purification system 102, for example. In particular implementations, processor 302, located in membrane cleaning unit 104, may perform process 502, but claimed subject matter is not limited in this respect.

At 504, processor 302, via transceiver 308, may receive, from water treatment unit 106, parameters of pre-treated and/or post-treated water that previously flowed through the membrane module while it was in water treatment unit 106. These parameters may be useful for determining the amount of fouling of the membrane module. Processor 302 may also receive, from water treatment unit 106, a history of performance of the membrane module, as measured (and saved as data in memory 204) by the water treatment unit.

At 506, processor 302 may, via sensors 312, measure parameters of the membrane module. Such parameters may include images of the surfaces of the membrane module. At 508, processor 302 may retrieve, from electronic memory 304, a history that includes cleaning processes previously applied to the membrane module and results of the cleaning processes. At 510, processor 302 may automatically clean the membrane module based on the parameters of the membrane module, the parameters of the water, and the history.

### Example Water Treatment System

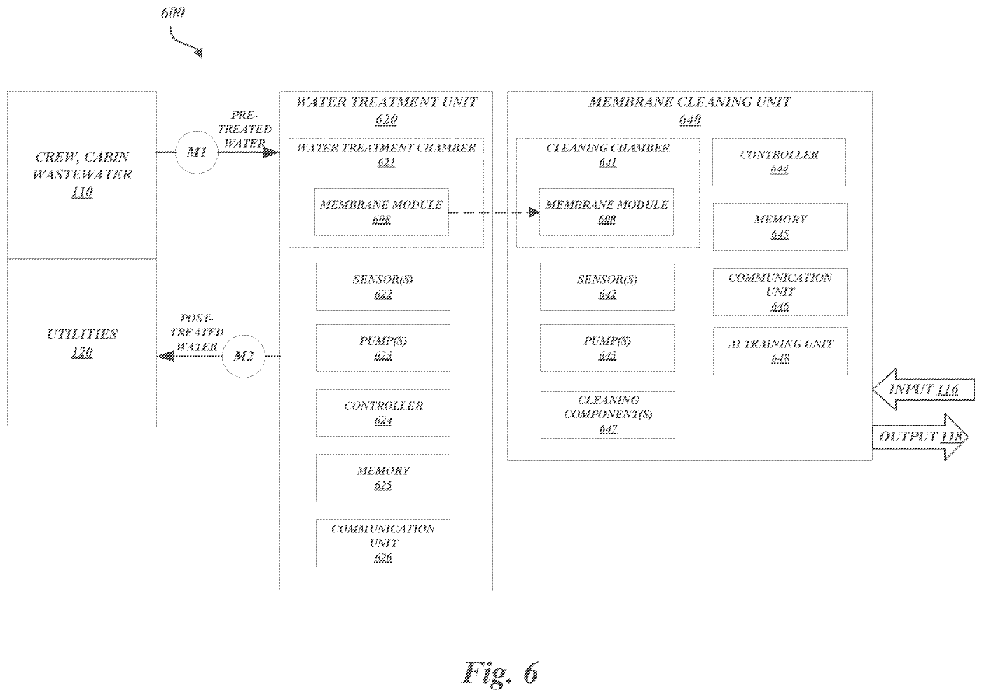

FIG. 6 is a block diagram depicting an example water treatment system 600 according to one embodiment. The water treatment system 600 can include cabin and crew wastewater 110 (hereinafter wastewater 110), utilities 120, a water treatment unit 620, sensors M1 and M2, and a membrane cleaning unit 640. In addition to and/or alternatively, the water treatment unit 620 and/or the membrane cleaning unit 640 can be combined into one unit and/or separate units.

Wastewater 110 can be the same as and/or similar to wastewater 110 of FIG. 1. which can include any water consumed and/or used by the crew and facilities of a spacecraft. For example, wastewater 110 can include salts, organics, and biological material, such as those found in urine, hygiene water, humidity condensate, bacteria, and the like. Wastewater 110, containing pre-treated water is transferred to the water treatment unit 620.

Utilities 120 can include any utility that a crewmember and/or the spacecraft may require purified water for. For example, utilities 120 can include a shower, a sink, a toilet, a humidifier and/or the like. Water used as part of utilities 120 can be clean potable water received from the water treatment unit 620. Once the clean water is consumed by the cabin and crew, the water may include wastewater 110. Sensors M1 and M2 can be the same and/or similar to sensors M1 and M2 of FIG. 1.

The water treatment system 600 can further include a water treatment unit 620. The water treatment unit 620 can purify cabin and crew wastewater 110 via reverse osmosis, nanofiltration, ultrafiltration, microfiltration, forward osmosis, membrane distillation, pervaporation and/or the like. The purified wastewater can be transferred back to utilities 120. The water treatment unit 620 can include a water treatment chamber 621, a membrane module 608, sensor(s) 622, pump(s) 623, a controller 624, memory 625, and a communication unit 626.

In one example implementation, pre-treated cabin and crew wastewater 110 can be transferred via pump(s) 623. The pump(s) 623 can be any type of pump designed to transfer pre-treated water to the water treatment unit 620, transfer liquids through the various components of the water treatment unit 620 (e.g., the water treatment chamber 621, the membrane module 608, or the like), and/or transfer post-treated water to utilities 120 of the spacecraft. The pump(s) 623 can include, for example, one or more positive displacement, rotary vane, diaphragm, gear pumps, centrifugal pumps and/or the like. Pump(s) 623 may be electrically connected to the controller 624 such that the controller 624 energizes the pump(s) 623.

The water treatment unit 620 may further include a water treatment chamber 621. The water treatment chamber 621 can receive pre-treated water from, for example, cabin and crew wastewater 110 via pump(s) 623, house a membrane module 608, and/or discharge post-treated water to utilities 120 via pump(s) 623. The water treatment chamber 621 can be used to house one or more membrane components used during operation of the water treatment unit 620. For example, the water treatment chamber 621 can include one or more sensor(s) 622, pump(s) 623, and/or a membrane module 608.

The membrane module 608 can be, for example, a filter used to remove various impurities such as urine, hygiene water, humidity condensate, and the like, from cabin and crew wastewater 110. The membrane module 608 can be configured, for example, in a spiral-wound or hollow fiber form factor or the like. The membrane module 608 can be used as part of the water treatment unit 620 to perform several cleaning tasks, such as reverse osmosis, nanofiltration, ultrafiltration, microfiltration or the like. Over time, deposits on the surface of the membrane module 608, such as salts, organics, biological materials, and the like, can degrade membrane performance. Eventually, the performance of a membrane module 608 will degrade to the point where the membrane must be taken off-line and cleaned, and/or or replaced altogether. A degraded membrane module 608 can be removed from the water treatment unit 620 either manually, by a crewmember and/or automatically via an automated process.

The water treatment unit 620 can include one or more sensor(s) 622. Sensor(s) 622 can be included inside, and/or external to the water treatment chamber 621, the water treatment unit 620, or the like. The sensor(s) 622 can be used to determine one or more parameters of the water treatment unit 620, such as pressure (e.g., differential and/or absolute), temperature, flow, level, electrical conductivity of the fluid and/or membrane module 608, turbidity, the presence of one or more chemicals in wastewater, one or more electrical characteristics of the pump(s) 623 (e.g., current, voltage, power consumed, RPM, intake/discharge pressure) or the like. Additionally and/or alternatively, some sensor(s) 622 can be located inside the water treatment chamber 621 while others may be located external to the water treatment chamber 621. The sensor(s) 622 can be electrically connected to the controller 624. The sensor(s) 642 may transmit characteristics of the water treatment unit 620 to the controller 624.

The water treatment unit 620 can further include a controller 624, memory 625, and a communication unit 626. The water treatment unit 620 can store information obtained by the controller 624 in memory 625. Examples of information stored in memory 625 include operational sensor data, membrane module identification data, and/or historical data. Additionally, the water treatment unit 620 includes a communication unit 626. The communication unit 626 can transmit and/or receive data from, for example, the membrane cleaning unit 640. For example, the communication unit 626 may receive membrane cleaning strategy data from the membrane cleaning unit 640, and/or transmit operational sensor data, membrane module identification data, forensic fouling analysis, and/or historical data to the membrane cleaning unit 640.

Further, the water treatment unit 620 includes a controller 624. The controller 624 can be any type of programmable logic controller (PLC) and/or microprocessor configured to process received commands from the communication unit 626, send and retrieve data from the memory 625, and/or receive and calculate operating parameters, and/or energize one or more components of the water treatment unit 620 such as, such as the pump(s) 623 and/or sensor(s) 622.

In an illustrative example, the controller 624 can receive from the communication unit 626, a command originating from the membrane cleaning unit 640 to transfer a membrane module 608 from the water treatment unit 620 to the membrane cleaning unit 640. The controller 624 may then transmit to the membrane cleaning unit 640, operational sensor data, membrane module identification data, forensic fouling analysis data, and/or historical data for the membrane module 608 to the membrane cleaning unit 640.

Operational sensor data can include, for example, a time-stamped log of sensor data described herein, such as from sensor(s) 622, sensor(s) 642. Time-stamped sensor data can include, but is not limited to pressure (e.g., differential and/or absolute), temperature, flow, level, electrical conductivity of the fluid and/or membrane module, turbidity, the presence of one or more chemicals in wastewater, one or more electrical characteristics of the pump(s) 623 (e.g., current, voltage, power consumed, RPM, intake/discharge pressure) or the like.

Membrane module identification data can include a unique identifier for a membrane module 608 being transferred from the water treatment unit 620 to the membrane cleaning unit 640. Historical data can include a historical record of past cleaning strategies applied to one or more membrane modules 608, historical performance data associated with one or more membrane modules 608 based on an applied cleaning strategy, and/or historical operational data associated with one or more membrane modules 608. Further, the transferred data may be used by the membrane cleaning unit 640 to determine an optimized cleaning strategy for the membrane module 608.

Historical data may originate from, for example, sensor(s) 622 while a membrane used in a water treatment unit 620, sensor(s) 642 while a membrane is cleaned as part of a membrane cleaning unit 640, or another portion of the water treatment unit. Additionally, historical data, operational sensor data, and/or membrane module identification data can include any type of data as described herein. Further one or more sets of data can be combined into one data set and/or partitioned into several data sets.

Forensic fouling analysis can include results of one or more tests conducted on a membrane module including testing for organic fouling, biological fouling, metallic fouling, colloidal particulate fouling, or the like.

The water treatment system 600 can further include a membrane cleaning unit 640. The membrane cleaning unit 640 can eliminate the need for human intervention during membrane module 608 cleaning and can produce a more thorough cleaning by selecting a specific sequence of cleaning techniques to apply to a membrane module 608. The membrane cleaning unit 640 can be located remotely and/or adjacent to the water treatment unit 620. The membrane cleaning unit 640 may be physically separated from a water treatment unit 620 and/or attached to a portion of the water treatment unit 620. Advantageously, having a membrane cleaning unit 640 separate from, but near (and/or adjacent to) the water treatment unit 620 can allow for parallel filtration for the water treatment system 600. Parallel filtration enables dual functionality, such that one membrane module 608 can be cleaned in the membrane cleaning unit 640 while another is operating within the water treatment unit 620. Thereby the water treatment unit 620 can continue operation during a membrane module 608 cleaning cycle.

The membrane cleaning unit 640 can include a cleaning chamber 641, a membrane module 608, sensor(s) 642, pump(s) 643, cleaning component(s) 647, a controller 644, memory 645, a communication unit 646, and an artificial intelligence (AI) training unit 648.

The pump(s) 643 can be any type of pump designed to support cleaning a membrane module 608, and/or transfer liquids associated with cleaning the membrane module 608. The pump(s) 643 can include, for example, one or more positive displacement, rotary vane, diaphragm, gear pumps, centrifugal pumps and/or the like. Pump(s) 643 may be electrically connected to the controller 644 such that the controller 644 energizes the pump(s) 643.

The membrane cleaning unit 640 may further include a cleaning chamber 641. The cleaning chamber 641 can be used to clean a membrane module 608. The cleaning chamber 641 can house one or more sensor(s) 642, pump(s) 643, and/or the membrane module 608. Optionally, the cleaning chamber 641 can house cleaning component(s) 647 to support one or more of the membrane module 608 cleaning sequences as described below.

The membrane cleaning unit 640 can include one or more sensor(s) 642. Sensor(s) 642 can be included inside, and/or external to the cleaning chamber 641. The sensor(s) 642 can be used to determine one or more parameters of the membrane cleaning unit 640 such as for example, pressure (e.g., differential and/or absolute), temperature, flow, level, electrical conductivity of the fluid and/or membrane module, turbidity, the presence of one or more chemicals in a cleaning solution, one or more electrical characteristics of the pump(s) 643 (e.g., current, voltage, power consumed, RPM, intake/discharge pressure) or the like. Additionally and/or alternatively, some sensor(s) 642 can be located inside the cleaning chamber 641 while others may be located external to the cleaning chamber 641. The sensor(s) 642 can be electrically connected to the controller 644. The sensor(s) 642 may transmit characteristics of the membrane cleaning unit 640 to the controller 644.

The membrane cleaning unit 640 can further include a controller 644, memory 645, and a communication unit 646. The membrane cleaning unit 640 can store information obtained by the controller 644 in memory 645 (e.g., operational sensor data, membrane module identification data, historical data, one or more cleaning cycle routines, etc.). Additionally, the membrane cleaning unit 640 includes a communication unit 646. The communication unit 646 can transmit and/or receive data from, for example, the water treatment unit 620. For example, the communication unit 646 may receive operational sensor data, membrane module identification data, and/or historical data from the water treatment unit 620.

Additionally, the membrane cleaning unit 640 can include a controller 644. The controller 644 can be any type of programmable logic controller (PLC) and/or microprocessor configured to process received commands from the communication unit 646, send and retrieve data from the memory 645, receive and calculate operating parameters, and/or energize one or more components of the membrane cleaning unit 640, such as the pump(s) 643, sensor(s) 642, cleaning component(s) 647, and/or AI training unit 648.

In some implementations, the membrane cleaning unit 640 can use artificial intelligence (e.g., machine learning, neural networks, language models, etc.) to identify an optimized cleaning strategy for one or more membrane modules 608. For example, the controller 644 may transmit operational sensor data, membrane module identification data, forensic fouling analysis data, and/or historical data to the AI training unit 648. The AI training unit 648 may form training data using the operational sensor data, membrane module identification data, forensic fouling analysis data, and/or historical data. For example, the AI training unit 648 may generate individual training data items that form the training data, where each training data item corresponds to a particular cleaning session and includes the operational sensor data, membrane module identification data, forensic fouling analysis data, and/or historical data (e.g., which includes an indication of the sequence of cleaning techniques used to clean the membrane module 608 in the respective cleaning session) for the respective cleaning session and is labeled with an indication of a number of cleaning cycles that were required to clean the membrane module 608 and/or the effectiveness of the membrane module cleaning (e.g., cleaning performance data, such as a percentage of the membrane module 608 that was cleaned such that an amount of particulate matter on the membrane module 608 falls below a threshold value, a percentage of the membrane module 608 that was not cleaned such that an amount of particulate matter on the membrane module 608 is above a threshold value, etc.) during the respective cleaning session. The AI training unit 648 can then train an AI model using the training data to predict a sequence of cleaning techniques that may reduce a number of cleaning cycles to clean a membrane module 608 given current operational sensor data, membrane module identification data, and/or forensic fouling analysis data. Further, the AI training unit 648 may predict an estimated operational lifecycle for one or more membrane modules 608 based on data gathered from operation of one or more membrane modules, historical data, forensic fouling analysis, and/or the like.

Once the AI model is trained, the controller 644 can use the trained AI model to determine a sequence of cleaning techniques to execute. For example, the controller 644 can apply or provide current operational sensor data, membrane module identification data, and/or forensic fouling analysis data corresponding to the membrane module 608 to be cleaned as an input to the trained AI model, which may cause the AI model to output an indication of a sequence of cleaning techniques to execute to clean the membrane module 60. The controller 644 can then cause the sequence of cleaning techniques to be executed in a manner as described herein.

Cleaning component(s) 647 can include one or more cleaning solutions and/or components for executing one or more cleaning cycles (e.g., also referred to herein as one or more “cleaning techniques”) associated with the membrane cleaning unit 640 (e.g., one or more chemical solutions and/or one or more components for applying physical force to the membrane module as describe herein). Cleaning cycles using cleaning component(s) 647 can be performed automatically based on a command from, for example controller 644. For example, cleaning component(s) 647 can include heater(s), high-pressure pump(s), one or more electrodes, one or more motors (e.g., motors used to vibrate the membrane module, generate ultrasonication or aeration of a cleaning solution), or the like. The membrane cleaning unit 640 can perform chemical and/or physical cleaning cycles on a membrane module 608 utilizing one or more cleaning component(s) 647.

Example cleaning cycles can include, a recirculation cycle, a physical dislodging cycle, a backwashing cycle, an applied electric field cycle, and/or the like. Each of these cleaning cycles are effective at removing inorganic scale (e.g., carbonate and phosphate salts), organic fouling with low adhesive forces (e.g., organic acids), biological fouling (e.g., polysaccharides), and/or colloidal/particulate deposits. Example cleaning cycles are briefly described next.

A recirculation cleaning cycle can include applying a chemical solution to the membrane module 608. In one implementation, the chemical solution can include an acidic solution to remove, for example, inorganic salt scale (e.g., hydrochloric acid and/or citric acid). In one implementation, the chemical solution can include a caustic chemical solution to remove, for example, organic fouling. Additionally, the caustic chemical solution can include an oxidizing agent such as, for example, hydrogen peroxide, ozone, chlorine and/or the like. In one implementation, the chemical solution can include a chelating agent to remove, for example, absorbed metals and divalent cations (e.g., ethylenediaminetetraacetic acid (EDTA). In one implementation, the chemical solution can include a surfactant, to remove organic macromolecules (e.g., sodium dodecyl sulfate). In some implementations, the chemical cleaning can combine one or more chemical solutions and/or apply one chemical solution at a time. In one example implementation, the applied chemical solutions can be temperature controlled (e.g., heated and/or cooled to a specific temperature before application).

A physical dislodging cleaning cycle can include applying a physical force to the membrane module 608. In some implementations, the physical force applied to the membrane module 608 can include ultrasonication with a recirculating fluid (e.g., alternating low-pressure and high-pressure waves in liquids, leading to the formation and violent collapse of small vacuum bubbles). In some implementations, the physical force applied to the membrane module 608 can include a vibratory shear exerted on the membrane module 608. In some implementations, the physical force applied to the membrane module 608 can include an aerated solution for microbubble and nanobubble surface scouring.

A backwashing cleaning cycle can include, for example, reversing the flow of liquid through the membrane module 608. Additionally, in one implementation, backwashing can include osmotic backflushing where a reverse concentration gradient is created by reversing flow (e.g., via pump(s) 643) and replacing the feed solution with a solution of high ionic strength (e.g., seawater, RO brine, and/or the like).

An applied electric filed cleaning cycle can include applying an electric field for electrically-induced desorption of charged foulants. In one implementation, the electric field cleaning cycle can be applied directly to conductive membrane modules 608 and/or via an electrode for non-conductive membrane modules 608. In one implementation, the electric field cleaning cycle can include a reactive species generation, such as hydroxyl radicals, by electrically-active particles within the membrane film, such as TiO₂.

Additionally and/or alternatively, a membrane cleaning strategy can include one or more cleaning cycles and/or an intensity of cleaning cycles as determined by controller 644. A cleaning strategy can include any sequence of cleaning cycles (e.g., any sequence of cleaning techniques). In one example a cleaning strategy can include first performing a recirculation cycle, then a physical dislodging cycle, followed by a backwashing cycle, and last, an applied electric field cycle. Further, a cleaning strategy can include one or more of the same cleaning cycles. In one example, a cleaning strategy can include a backwashing cycle, an applied electric field cycle, and a second backwashing cycle. Additionally and/or alternatively, the membrane cleaning unit 640 can perform one or more cleaning cycles simultaneously as determined by the controller 644. For example, the membrane cleaning unit 640 can perform a backwashing cycle and/or a physical dislodging cycle at the same time.

Further, cleaning component(s) 647 and/or other supplies may be supplied via input 116 and/or drained via output 118. In an additional implementation, one or more sensor(s) 642, such as any of the sensors described herein, may be used to evaluate waste solution via output 118. Further, the evaluation of waste solution via output 118 can be used to minimize overall consumables such that spent cleaning solution may be recycled so long as the system determines that the solution does not sacrifice cleaning performance.

### Example Operational Environment

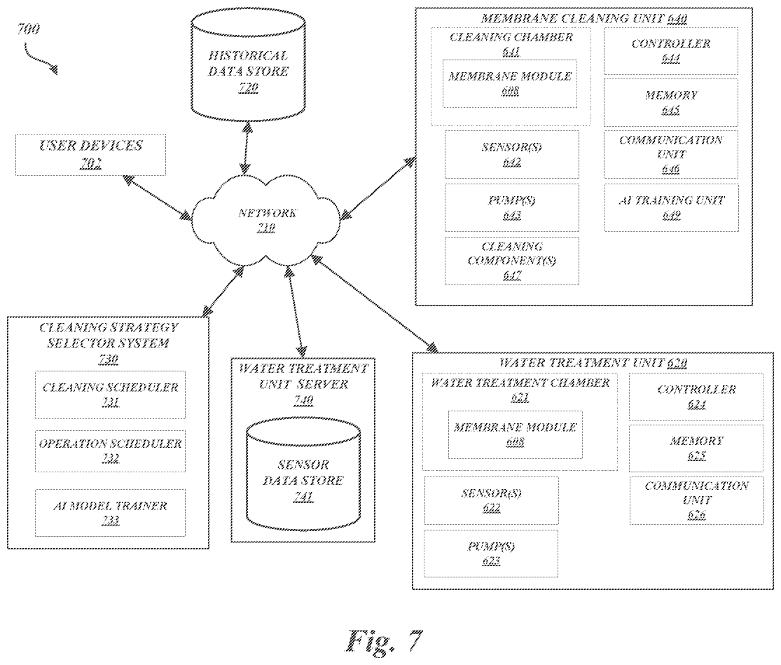

FIG. 7 is a block diagram of an illustrative operating environment 700 in which an automated cleaning strategy selector system 730 uses historical data via historical data store 720, and operational sensor data via sensor data store 741 to determine an optimized cleaning strategy (e.g., an optimized sequence of cleaning techniques) for the membrane cleaning unit 640. The operating environment 700 may further include a water treatment unit 620, that may transmit operational data, such as any of the sensor data described herein, via network 710 to the sensor data store 741. Additionally, the operating environment 700 can further include a membrane cleaning unit 640 with which the cleaning strategy selector system 730 may communicate one or more determined membrane cleaning strategies and/or instructions associated with one or more cleaning cycles. The operating environment 700 further includes various user devices 702 that may communicate with the cleaning strategy selector system 730, the membrane cleaning unit 640, and/or the water treatment unit 620 to provide the user with an indication that one or more cleaning strategies were determined and/or provide a status of one or more components of the operating environment.

The cleaning strategy selector system 730 can be a computing system configured to select the most optimal cleaning strategy for a membrane cleaning unit 640. For example, the cleaning strategy selector system 730 can receive a membrane module's operational sensor data, forensic fouling analysis data, historical data, and/or user device input to determine a cleaning strategy that will maximize useful life of the membrane module. The cleaning strategy selector system 730 can be located internal to a spacecraft in which the membrane module 608 is located or external to the spacecraft (e.g., at a space station, at a ground station, etc.).

The cleaning strategy selector system 730 may be a single computing device, or it may include multiple distinct computing devices, such as computer servers, logically or physically grouped together to collectively operate as a server system. The components of the cleaning strategy selector system 730 can be implemented in application-specific hardware (e.g., a server computing device with one or more ASICs) such that no software is necessary or as a combination of hardware and software. In addition, the modules and components of the cleaning strategy selector system 730 can be combined on one server computing device or separated individually or into groups on several server computing devices. In some embodiments, the cleaning strategy selector system 730 may include additional or fewer components than illustrated in FIG. 7.

The cleaning strategy selector system 730 can include various modules, components, data stores, and/or the like to provide an optimal cleaning strategy as described herein. For example, the cleaning strategy selector system 730 can include a cleaning scheduler 731, an operational scheduler 732, and/or an AI model trainer 733.

The cleaning scheduler 731 can determine, based on data from the water treatment unit 620, whether a membrane module 608 operating as part of a water treatment unit 620 requires cleaning. For example, the controller 624 may determine that a differential pressure, a conductivity measurement, or the like, across a membrane module has met or exceeded a threshold. Once the controller 624 determines that a pressure has met or exceeded a threshold, an indication may be transmitted via communication unit 626 to the cleaning scheduler 731. In addition to the transmitted sensor data from the water treatment unit 620, the cleaning scheduler 731 may receive data from the historical data store 720 to determine whether to schedule a cleaning for a membrane module 608. The historical data store 720 database may include membrane module 608 specific data, and/or data based on the performance of one or more membrane modules as described herein. In addition, the cleaning scheduler 731 may receive, via network 710 a user input via user devices 702. The user devices 702 can include a device that depicts any user interface designed to provide an indication and status of the water treatment system 600 to crew members and/or third parties, such as at a ground station. A user device 702 can be located onboard a spacecraft or external to a spacecraft (e.g., at a space station, at a ground station, etc.). A user device 702 can receive input that can include, for example, a request to perform one or more cleaning cycles for a membrane module. Furthermore, the cleaning scheduler 731 can extract information to determine whether to clean a membrane module and forward the appropriate membrane module data to the operational scheduler 732.

Once the cleaning scheduler 731 receives data associated with a membrane module, the operational scheduler 732 can determine an optimized cleaning strategy to maximize the useful life of the membrane module 608. For example, the operational scheduler 732 may select one or more cleaning cycles from a listing of cleaning cycles based on a determined status of a membrane module 608. The status of the membrane module can be determined based on data associated with the latest operational sensor data for the membrane module, the age of the membrane module, a history of past cleaning cycles performed on the membrane module, environmental data from the operating environment that may indicate the primary fouling profile of the membrane module, or any other data described herein. Example cleaning cycles can include a recirculation cycle, a physical dislodging cycle, a backwashing cycle, an applied electric field cycle as described above. The operational scheduler 732 can transmit via network 710 the determined cleaning strategy to the membrane cleaning unit 640. The determined cleaning strategy can include a list of commands sent to the membrane cleaning unit 640 and/or an order and intensity of cleaning cycles to be performed on a membrane module 608.

The AI model trainer 733 can be utilized by the cleaning strategy selector system 730 to further optimize cleaning strategies. The AI model trainer 733 can use artificial intelligence (e.g., machine learning, neural networks, language models, etc.) to identify discrepancies between determined cleaning strategies and membrane module 608 operational performance. Further, the cleaning strategy selector system 730 may use an AI model trainer 733 to train a model to estimate the maximum operational performance, time until next cleaning cycle, and/or remaining useful life of a membrane module 608. The AI model trainer 733 can be trained using membrane specific data from the historical data store 720, operational sensor data from the water treatment unit server 740, live sensor data from the membrane cleaning unit 640 and/or water treatment unit 620, forensic fouling analysis data, and/or one or more inputs from user devices 702 that correspond to different cleaning sessions and that are labeled to indicate a number of cleaning cycles and/or an effectiveness of the membrane module cleaning during the respective cleaning session. The AI model trainer 733 can additionally be used to recognize and/or predict one or more faults associated with the membrane cleaning unit 640 and/or the water treatment unit 620 (e.g., degraded performance of one or more pumps, sensors, cleaning components, etc.). For example, the AI model trainer 733 can determine an operational model for the membrane cleaning unit 640 and/or the water treatment unit 620, and compare the operational model to live sensor data. The AI model trainer 733 may output an indication of a component and/or components that may be causing a discrepancy between the operational model and live data.

Optionally, the AI training unit 649 and/or the controller 644 of the membrane cleaning unit 640 can perform some or all of the operations described herein as being performed by the AI model trainer 733. Similarly, optionally the AI model trainer 733 can perform some or all of the operations described herein as being performed by the AI training unit 649 and/or the controller 644.

The water treatment unit server 740 can be a computing system configured to store and provide access to a database of water treatment unit 620 operational data. For example, a water treatment unit server 740 can obtain sensor data from water treatment unit 620 via network 710. The water treatment unit server 740 can store sensor data in, for example, the sensor data store 741. Sensor data can include, for example, a time-stamped log of any sensor data described herein, such as pressure (e.g., differential and/or absolute), temperature, flow, level, electrical conductivity of the fluid and/or membrane module, turbidity, the presence of one or more chemicals in wastewater, one or more electrical characteristics of the pump(s) 623 (e.g., current, voltage, power consumed, RPM, intake/discharge pressure) or the like. The water treatment unit server 740 can be located internal to the spacecraft in which the membrane module 608 to be cleaned is located or external to the spacecraft (e.g., at a space station, at a ground station, etc.).

The historical data store 720 may be data associated with the historical operation and performance of one or more membrane modules 608 as described herein. For example, the historical data store 720 may include membrane module identification data (e.g., model and/or serial numbers, date manufactured, lot number, expiration date, or the like). The historical data store 720 may further include data associated with past cleaning cycles performed on one or more membrane modules. Additionally, historical data can include past operational data of one or more membrane modules 608. Data such as a historical record of past cleaning cycles performed on a specific membrane module may be accessed by the cleaning strategy selector system 730 to determine an optimized cleaning strategy for a specific membrane module 608. Additionally, data stored in the historical data store 720 can be accessed, via network 710, by the cleaning strategy selector system 730 to determine one or more operational trends based on a one or more of cleaning strategies and/or individual cleaning cycles executed on several membrane modules.

As described above, the water treatment unit 620 can include a controller 624. memory 625, and a communication unit 626. The water treatment unit 620 can store information obtained by the controller 624 in memory 625 (e.g., operational sensor data, membrane module identification data, historical data, etc.). Additionally, the water treatment unit 620 includes a communication unit 626. The communication unit 626 can transmit and/or receive data from, for example the membrane module 608. For example, the communication unit 626 may receive historical data from the membrane cleaning unit 640, and/or transmit operational sensor data, membrane module identification data, a forensic fouling analysis, and/or a membrane module's historical data to the membrane cleaning unit 640, the water treatment unit server 740, the cleaning strategy selector system 730 and/or the historical data store 720.

In an illustrative example, the controller 624 can receive differential pressure data from one or more sensor(s) 622. The controller 624 may determine that the differential pressure from the sensor(s) 622 has exceeded a threshold value. The controller 624 may transmit, via network 710 to the cleaning strategy selector system 730, an indication that a differential pressure threshold has been exceeded. Additionally, the controller 624 may transmit the differential pressure indications to the sensor data store 741. The cleaning strategy selector system 730 may determine whether a membrane module requires cleaning based on the received controller data and/or along with other data described herein.

As described above, the membrane cleaning unit 640 can execute one or more cleaning cycles based on a determination by the operational scheduler 732. For example, the membrane cleaning unit 640 can execute a recirculation cycle, a physical dislodging cycle, a backwashing cycle, an applied electric field cycle, and/or the like. Each of these cleaning cycles are effective at removing inorganic scale (e.g., carbonate and phosphate salts), organic fouling with low adhesive forces (e.g., organic acids), biological fouling (e.g., polysaccharides), and/or colloidal/particulate deposits.

The controller 644 can receive one or more instructions to execute a cleaning strategy from the cleaning strategy selector system 730. The controller 644 may, in accordance with a received cleaning strategy received from the cleaning strategy selector system 730, energize pump(s) 643, energize one or more cleaning component(s) 647 as described herein, and/or request data from one or more sensor(s) 642. During cleaning and/or after cleaning a membrane module, the controller 644 may transmit, via network 710, data based on one or more cleaning strategies to the historical data store 720. Data transferred to the historical data store 720 can include membrane cleaning unit 640 sensor data acquired during cleaning, the determined cleaning strategy applied to a membrane module 608, membrane module identification data for the specific membrane cleaned, and/or results of the cleaning strategy. Additionally, the controller 644 may transmit an indication to user devices 702, including data associated with one or more cleaning strategies.

### Example Block Diagram for Determining a Membrane Module Cleaning Strategy

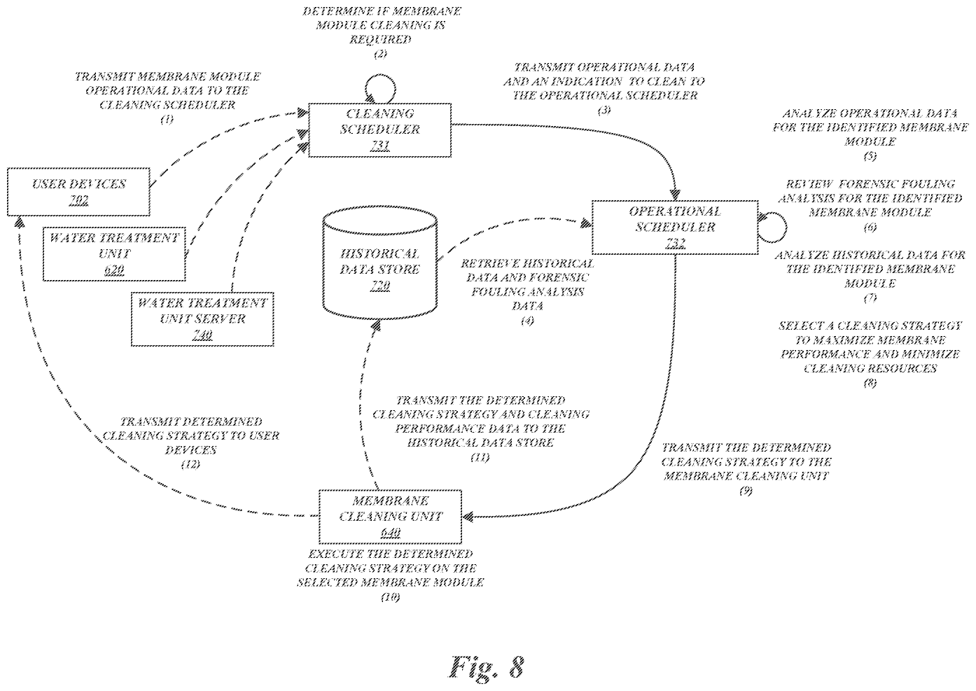

FIG. 8 is a flow diagram illustrating the operations performed by the components of the operating environment 700 of FIG. 7 to determine a cleaning strategy for a membrane module based on inputs from water treatment unit 620 and historical data from a server, such as the water treatment unit server 740.

As illustrated in FIG. 8, either user devices 702, water treatment unit 620, or water treatment unit server 740 transmits operational data to a cleaning scheduler 731 at (1). Operational data can include, sensor data associated with the operation of a membrane module 608 as part of the water treatment unit 620 such as differential and/or absolute pressure, temperature, flow, level, electrical conductivity of the fluid and/or membrane module, turbidity, the presence of one or more chemicals in wastewater, one or more electrical characteristics of pump(s) 623 (e.g., current, voltage, power consumed, RPM, intake/discharge pressure) or the like. Operational data can further include membrane module specific data such as a model number, serial number, date manufactured, lot number, expiration date, or the like. As an example, the water treatment unit 620 can transmit differential pressure data, pump flow rate, the turbidity of liquid (e.g., process water, such as feed, reject, or purified water into and/or out of the membrane module and/or water treatment unit 620), and conductivity measurements of a membrane module within the water treatment unit 620 to the cleaning scheduler 731. In an additional implementation, a user can transmit operational data via user devices 702 to the cleaning scheduler 731. The user can include cabin and crew members within a spacecraft, and/or a user at a remote location such as from a mission/flight control station. Operational data transmitted from user devices 702 can include any of the data described herein. Additionally, operational data can include an instruction from user devices 702, that a membrane module requires cleaning. In an additional implementation, the water treatment unit server 740 can transmit operational data as described herein to the cleaning scheduler 731. Further, the cleaning scheduler 731 may identify a membrane module 608 based on the membrane module operational data. The membrane module identification data can be used to determine the cleaning history and/or performance of a membrane module.

Once a membrane module is identified, the cleaning scheduler 731 can determine whether the identified membrane module requires cleaning at (2). Operational data for the identified membrane module is assessed by the cleaning scheduler 731 to determine whether the membrane module requires a cleaning. Determining whether a membrane module requires cleaning can be based on one or more characteristics of the membrane module, the water treatment unit 620 or the like. For example, the cleaning scheduler 731 may access water pressure data from one or more sensors of the water treatment unit 620. The pressure data may indicate that a differential pressure across a membrane module exceeds a threshold differential pressure value. Excess differential pressure may indicate that the membrane contains, for example, salts and deposits preventing liquids from flowing through the membrane module. In another example, the cleaning scheduler 731 can determine that a flow rate at the discharge of one or more pumps associated with the water treatment unit 620 has decreased below a threshold value, indicating that a membrane contains deposits and must be cleaned to restore flow. In a further example, sensor data may be used to determine that a high concentration of one or more chemicals are present in the post-treated water, indicating the membrane module's performance is degrading or the accumulation of the chemical has occurred on the membrane surface, such as with inorganic salt scaling.

Alternatively, one or more of the sensor data associated with the operational data may be used to determine whether a membrane requires cleaning. For example, a membrane may require cleaning when both a differential pressure threshold and a flow rate threshold are met. Additionally and/or alternatively, the cleaning scheduler 731 can determine that a membrane module requires cleaning based on a request from user devices 702.

Once the cleaning scheduler 731 has determined that the membrane module requires cleaning based on operational data and/or a user input from user devices 702, the cleaning scheduler 731 can transmit the indication to the operational scheduler 732 at (3).

The operational scheduler 732 can extract historical data from a historical data store 720 at (4). The historical data can include a historical record of cleaning cycles performed on one or more membrane modules, past forensic fouling analysis conducted for the identified membrane module, and/or historical operational data associated with one or more membrane modules. Historical data retrieved from a historical data store 720, along with the transmitted membrane operational data may be used by the operational scheduler 732 as part of determining a cleaning strategy for the current membrane module.

The operational scheduler 732 can then analyze the identified membrane module operational data at (5). The operational scheduler 732 may review, for example, water treatment unit 620 sensor data as described herein to determine the current status of a membrane module. For example, the operational scheduler 732 may determine based on sensor data that one or more deposits exist on the membrane module, such as large accumulation of inorganic salt scale (e.g., hydrochloric acid and/or citric acid), divalent cations (EDTA), charged foulants, or the like.

The operational scheduler 732 may further review forensic fouling analysis for the identified membrane module at (6). Forensic fouling analysis may provide insight, for example, as to whether one or more surfaces of the membrane are plugged and/or whether sticky polymeric precipitates exist on the membrane module.

In an example implementation, one or more of the following cleaning cycles can be selected by the operational scheduler 732 based on the following forensic fouling analysis: for a majority of organic fouling, cleaning with a caustic agent at elevated temperatures; for biological fouling, cleaning with biocide (oxidant such as hydrogen peroxide or ozone, and/or UV light) or bioactive cleaning agents, such as specialty enzymes or surfactant; for metallic fouling (e.g., iron-based fouling), cleaning with a chelating agent; for inorganic salt scaling (e.g., phosphate salt), cleaning with an acidic agent; and/or for colloidal particulate fouling/cake formation, cleaning with a shearing or scouring agent, such as vibration or aeration with high recirculation flow rates.

The operational scheduler 732 may also analyze historical data for the identified membrane module at (7). Historical data can include a historical record of each cleaning cycle performed on the membrane module, historical operational data of one or more membrane modules 608, post-cleaning results based on one or more cleaning strategies, or any other historical data described herein. For example, the historical cleaning performance data can include cleaning cycles and/or sensor data collected during one or more cleaning cycles from sensor(s) 642. Historical data can be used to identify the effectiveness of one or more cleaning cycles. Further, analyzing historical data may be used by the operational scheduler 732 to determine a cleaning strategy that efficiently and effectively utilizes cleaning resources. For example, a cleaning strategy may be selected by the operational scheduler 732 that reduces the volume of caustic chemical solutions required to effectively clean a membrane and/or eliminate cleaning cycles that are not necessary to clean the type of deposits existing on the membrane surface.

Further, the operational scheduler 732 may determine an intensity for one or more cleaning cycles, such as a high intensity cleaning and/or a low intensity cleaning. The intensity of a cleaning cycle can be, for example, an energy level as enabled by the controller 644 to one or more cleaning component(s) 647, and/or pump(s) 643 of the membrane cleaning unit 640 during a cleaning cycle. As an illustrative example, the intensity of a backflush cleaning cycle may be the amount of energy provided to one or more pump(s) 643 performing the backflush cycle (e.g., 10%, 50%, 90%, or 100% power). Further, the intensity of a cleaning cycle can include a duration. As an illustrative example, a physical dislodging cycle using a vibratory shear, may have a duration (e.g., 1, 5, 10, 100 minutes, etc.) depending on the determined intensity by the operational scheduler 732. The intensity of a cleaning cycle can also include a chemical composition of the cleaning cycle. Additionally, intensity can vary from cleaning cycle to cleaning cycle, based on the operational scheduler's 732 determined cleaning strategy.

The operational scheduler 732 may then select a cleaning strategy to maximize membrane performance and minimize cleaning resources at (8). The operational scheduler 732 may determine one or more cleaning cycles, a sequence for each cycle, and an intensity for each cycle, that optimally cleans a membrane module. As described above, example cleaning cycles can include, a recirculation cycle, a physical dislodging cycle, a backwashing cycle, an applied electric field cycle, and/or the like. Each of these cleaning cycles can be effective at removing inorganic scale (e.g., carbonate and phosphate salts), organic fouling with low adhesive forces (e.g., organic acids), biological fouling (e.g., polysaccharides), and/or colloidal/particulate deposits. The cleaning strategy can include one or more cleaning cycles and/or an intensity of cleaning cycles as determined by the operational scheduler 732. Cleaning strategies can be determined based on the operational scheduler 732 determination to conserve consumables, power, or time associated with the membrane cleaning process. Additionally, cleaning strategies can include a sequence of cleaning cycles that optimally cleans a membrane module to maximize membrane performance and minimize cleaning resources. Further, a cleaning strategy may eliminate and/or combine one or more cleaning cycles to expedite the membrane cleaning process.

In one example a cleaning strategy can include first performing a recirculation cycle, then a physical dislodging cycle, followed by a backwashing cycle, and last, an applied electric field cycle. Further, a cleaning strategy can include one or more of the same cleaning cycles. In one example, a cleaning strategy can include a backwashing cycle, an applied electric field cycle, and a second backwashing cycle. Further, a cleaning strategy can include one, two, three, four or more cleaning cycles. In one example a cleaning strategy includes an applied electric field cleaning cycle.

Once the operational scheduler 732 determines the optimal cleaning strategy, the operational scheduler 732 transmits the cleaning strategy to the membrane cleaning unit 640 at (9). For example, the operational scheduler 732 may transmit a set of instructions to the membrane cleaning unit 640, including one or more cleaning cycles. In one example, the set of instructions can be a cleaning strategy that instructs the membrane cleaning unit 640 to execute a first physical dislodging cycle, then a backwashing cycle, followed by an applied electric field cleaning cycle.

Once the membrane cleaning unit 640 receives instructions including a cleaning strategy, the membrane cleaning unit 640 can execute the cleaning strategy on the identified membrane module (10). The set of instructions can be, for example, computer-executable code instructing the membrane cleaning unit 640 to clean according to the determined strategy. The membrane cleaning unit 640 may receive the cleaning strategy and in turn, energize pump(s) 643 and/or cleaning component(s) 647 in accordance with the received cleaning strategy. During cleaning, the membrane cleaning unit 640 may receive sensor data from one or more sensor(s) 642 as described herein. The sensor data, along with the cleaning strategy can be transmitted to the historical data store 720 at (11). The historical data store 720 may store cleaning strategy and cleaning performance data from the membrane cleaning unit 640, to determine subsequent membrane cleaning strategies. Further, the membrane cleaning unit 640 may transmit the cleaning strategy to user devices 702 at (12). Alternatively or in addition, the membrane cleaning unit 640 can transmit a status and/or results from executing the membrane cleaning strategy to the user devices 702 such that, for example, a crewmember may receive indication of the determined cleaning strategy via a graphical user interface.

### Example Block Diagram for Training an AI Model

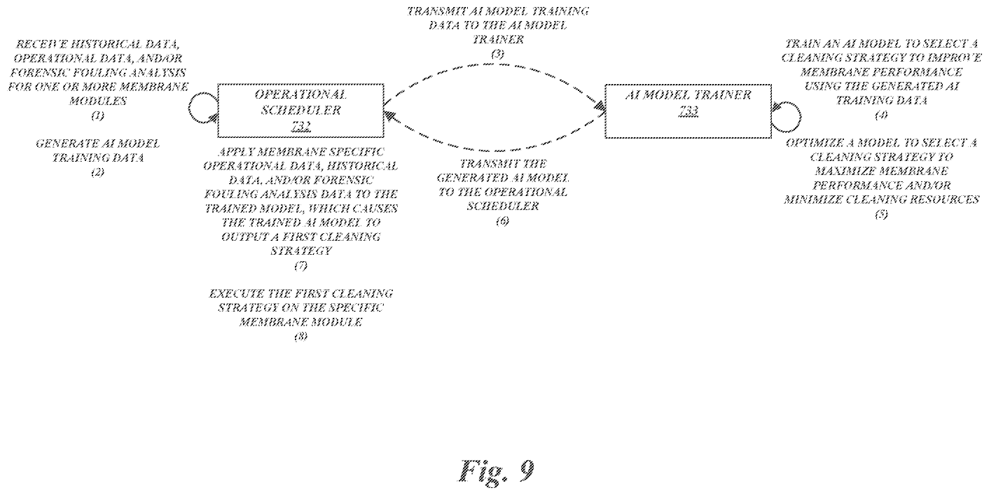

FIG. 9 is a flow diagram illustrating the operations performed by the components of the operating environment 700 of FIG. 7 to train one or more AI models to determine a cleaning strategy for a membrane module based on inputs and historical data from a server, such as the water treatment unit server 740.

As illustrated in FIG. 9, the operational scheduler 732 can receive historical data, operational data and/or forensic fouling analysis data for one or more membrane modules at (1). The data can be generated while one or more membrane modules are operating as part of, for example, a water treatment system 600. Operational data can include, for example, a time-stamped log of sensor data described herein, such as from sensor(s) 622, sensor(s) 642. Time-stamped sensor data can include, but is not limited to pressure (e.g., differential and/or absolute), temperature, flow, level, electrical conductivity of the fluid and/or membrane module, turbidity, the presence of one or more chemicals in wastewater, one or more electrical characteristics of the pump(s) 623 (e.g., current, voltage, power consumed, RPM, intake/discharge pressure) or the like.

Historical data may originate from, for example, sensor(s) 622 while a membrane used in a water treatment unit 620, sensor(s) 642 while a membrane is cleaned as part of a membrane cleaning unit 640, or another portion of the water treatment system 600.

Historical data can additionally include membrane module identification data such as a unique identifier for a membrane module 608 being transferred from the water treatment unit 620 to the membrane cleaning unit 640. Historical data can include a historical record of past cleaning strategies applied to one or more membrane modules 608, historical performance data associated with one or more membrane modules 608 based on an applied cleaning strategy, and/or historical operational data associated with one or more membrane modules 608.

Forensic fouling analysis can include results of one or more tests conducted on a membrane module including testing for organic fouling, biological fouling, metallic fouling, colloidal particulate fouling, or the like.

Once the operational scheduler 732 receives historic data, operational data, and/or forensic fouling analysis data, the operational scheduler 732 can generate AI model training data at (2). After the operational scheduler 732 has generated the AI model training data, the operational scheduler 732 can transmit the AI model training data to the AI model trainer 733 at (3).

The AI model trainer 733 can receive the AI model training data and train an AI model to select a cleaning strategy to improve membrane performance at (4). The model can be trained using any modeling technique (e.g., machine learning, neural networks, language models (e.g., large language models), etc.) to select a sequence of cleaning cycles and apply an intensity for each cleaning cycle. The model can be trained to receive the most recent operational data for a membrane module 608, and based on the training data, generate the sequence of cleaning cycles. The one or more cleaning cycles can include, for example, a recirculation cycle, a physical dislodging cycle, a backwashing cycle, an applied electric field cycle, and/or the like.

Further, the AI model trainer 733 can optimize a trained AI model, to select a cleaning strategy to maximize membrane performance and/or minimize cleaning resources at (5). For example, the AI model trainer 733 can train a model to predict one or more faults associated with the membrane cleaning unit 640 and/or the water treatment unit 620 (e.g., degraded performance of one or more pumps, sensors, cleaning components, etc.) by determining an operational model for the membrane cleaning unit 640 and/or the water treatment unit 620, and comparing the operational model to live sensor data during membrane cleaning and/or operation of a membrane module 608. Advantageously, enabling the AI model trainer 733 to train a model to predict discrepancies within the water treatment system 600 can reduce consumables and maximize membrane performance by eliminating unnecessary cleanings when another component of the system may be degraded.

Next the AI model trainer 733 can transmit the generated AI model to the operational scheduler 732 at (6).

Once the AI model trainer 733 has transmitted the generated AI model, the operational scheduler 732 may apply membrane specific operational data, historical data, and/or forensic fouling analysis data to the trained model, which causes the trained AI model to output a first cleaning strategy at (7). The membrane specific operational data, historical data, and/or forensic fouling data can be any of the data described herein. The data can be data gathered by, for example, sensor(s) 622 while the specific membrane module 608 was in operation. Further the first strategy can be any sequence of cleaning cycles and/or an intensity for each cleaning cycle as described herein.

After the operational scheduler 732 has received an output of a first cleaning strategy for the specific membrane module, the operational scheduler 732 can execute the first cleaning strategy on the specific membrane module 608 at (8). The specific cleaning strategy can be any strategy as described herein. The operational scheduler 732 can execute the cleaning strategy via, for example, the membrane cleaning unit 640.

### Example Cleaning Strategy Selector Routine

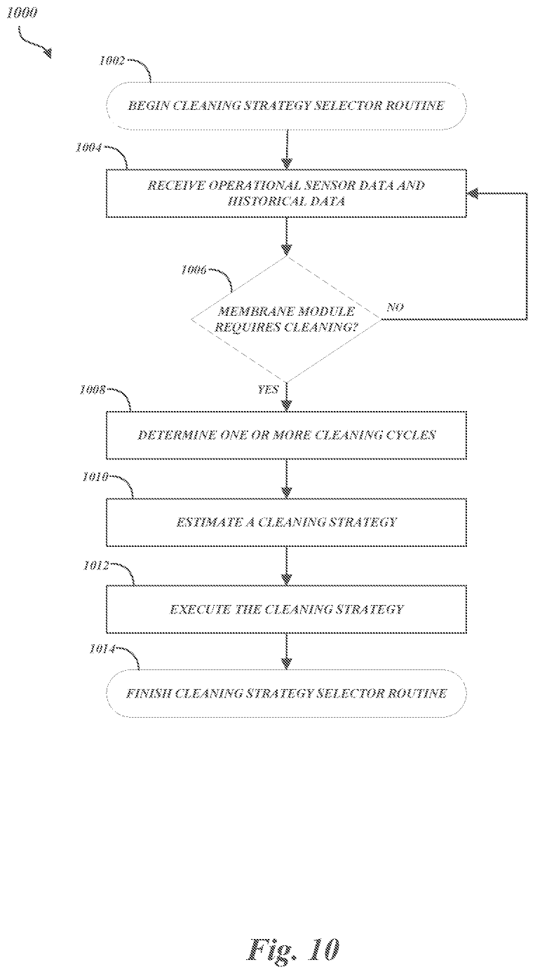

FIG. 10 is an example flow chart of a cleaning strategy selector routine 1000 illustratively implemented by a water treatment system 600 according to one embodiment. As an example, the membrane cleaning unit 640 of FIG. 6 (e.g., controller 644) can be configured to execute the cleaning strategy selector routine 1000. The cleaning strategy selector routine begins at block 1002.

At block 1004, the controller 644 can receive operational sensor data and historical data. Operational sensor data can include data collected while a membrane module 608 is used as part of a water treatment unit 620. Operational sensor data can include, for example, a time-stamped log of sensor data, such as from sensor(s) 622. Time-stamped sensor data can include, but is not limited to pressure (e.g., differential and/or absolute), temperature, flow, level, electrical conductivity of the fluid and/or membrane module, turbidity, the presence of one or more chemicals in wastewater, one or more electrical characteristics of the pump(s) 623 (e.g., current, voltage, power consumed, RPM, intake/discharge pressure) or the like. Historical data can include a historical record of past cleaning strategies applied to one or more membrane modules 608, historical performance data associated with one or more membrane modules 608 based on an applied cleaning strategy, and/or historical operational data associated with one or more membrane modules 608. Historical data may originate from, for example, sensor(s) 622 while a membrane used in a water treatment unit 620, sensor(s) 642 while a membrane is cleaned as part of a membrane cleaning unit 640, or another portion of the water treatment unit.

At decision node 1006, the controller 644 determines whether a membrane module requires cleaning. If the controller 644 determines that the membrane module 608 requires cleaning, then the routine 1000 continues to block 1008. If the controller 644 determines that the membrane module does not require cleaning, then the routine loops back to block 1004. The controller 644 may determine that a membrane module 608 requires cleaning based on for example, one or more sensor(s) 622 meeting and/or exceeding a threshold value while a membrane module 608 is used as part of a water treatment unit. For example, the controller 644 may determine that a membrane module 608 requires cleaning based on one or more of the differential pressure measured across the membrane cleaning unit, a conductivity of the membrane module or process water, a turbidity of the process water, a flow rate of the process water, a current from one or more pumps of the water treatment unit, a discharge pressure from one or more pumps of the water treatment unit, or a detection of one or more chemicals in the wastewater.

At block 1008, the controller 644 determines one or more cleaning cycles for the membrane module. The cleaning cycles can include one or more of the cleaning cycles mentioned above (e.g., a recirculation cleaning cycle, a physical dislodging cleaning cycle, a backwashing cleaning cycle, an applied electric field cleaning cycle, or the like). The controller 644 may determine one or more cleaning cycles for the membrane based on the received operational sensor data and/or the received historical data. Further, the controller 644 may determine an intensity for the one or more cleaning cycles. The intensity can be based on the quantity of one or more materials and/or chemicals observed on the membrane module and/or based on sensor data during operation. In addition to or alternatively, the controller 644 may use forensic fouling analysis data to determine one or more cleaning cycles and/or an intensity for the one or more cleaning cycles.

At block 1010, the controller 644 may estimate a cleaning strategy for the membrane module 608. The cleaning strategy can include one or more cleaning cycles, a sequence for the one or more cleaning cycles, and/or an intensity for each cleaning cycle. The cleaning strategy may be determined to conserve consumables, power, or downtime associated with the membrane cleaning process. Additionally, cleaning strategies can include a sequence of cleaning cycles that optimally cleans a membrane module to maximize membrane performance and minimize cleaning resources. Further, a cleaning strategy may eliminate and/or combine one or more cleaning cycles to expedite the membrane cleaning process.

At block 1012, the controller 644 may execute the cleaning strategy. For example, the controller 644 may energize or activate one or more pump(s) 643, cleaning component(s) 647 or the like, and receive data from sensor(s) 642 in accordance with the determined cleaning strategy. In an example implementation, a cleaning strategy can include first performing a recirculation cycle, then a physical dislodging cycle, followed by a backwashing cycle, and last, an applied electric field cycle. Further, a cleaning strategy can include one or more of the same cleaning cycles. In one example, a cleaning strategy can include a backwashing cycle. an applied electric field cycle, and a second backwashing cycle. Further, a cleaning strategy can include one, two, three, four or more cleaning cycles. In one example a cleaning strategy includes an applied electric field cleaning cycle. Once the cleaning strategy is executed by the controller the routine 1000 ends at block 1014.

### Additional Example Implementations and Details

In an implementation the system (e.g., one or more aspects of the system 102. 600, one or more aspects of the computing environment 100, 700, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 10) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application.” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices.” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

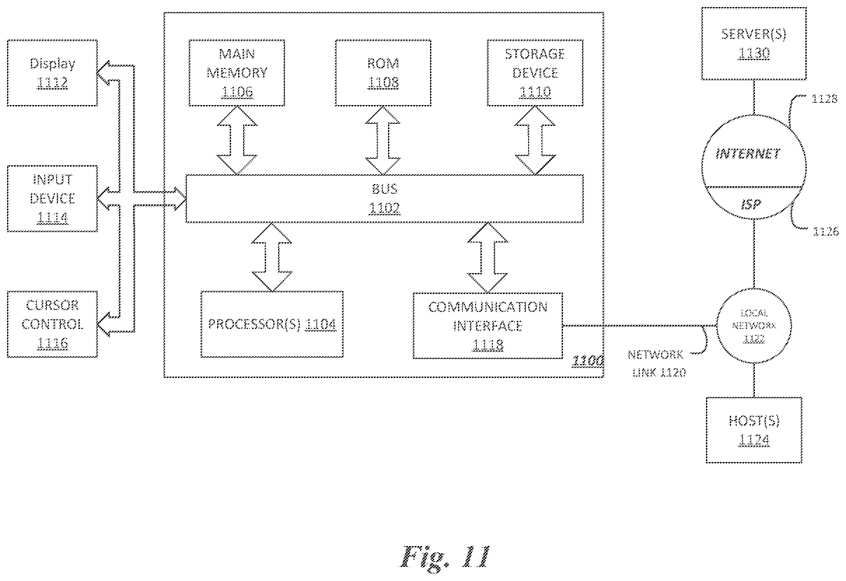

For example, FIG. 11 shows a block diagram that illustrates a computer system 1100 upon which various implementations and/or aspects (e.g., one or more aspects of the operating environment 700, one or more aspects of the water treatment system 600, one or more aspects of the water treatment unit 620, one or more aspects of membrane cleaning unit 640, and/or the like) may be implemented. Multiple such computer systems 1100 may be used in various implementations of the present disclosure. Computer system 1100 includes a bus 1102 or other communication mechanism for communicating information, and a hardware processor, or multiple processors, 1104 coupled with bus 1102 for processing information. Hardware processor(s) 1104 may be, for example, one or more general purpose microprocessors.

Computer system 1100 also includes a main memory 1106, such as a random-access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions. The main memory 1106 may, for example, include instructions to implement server instances, queuing modules, memory queues, storage queues, user interfaces, and/or other aspects of functionality of the present disclosure, according to various implementations.

Computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), and/or the like, is provided and coupled to bus 1102 for storing information and instructions.

Computer system 1100 may be coupled via bus 1102 to a display 1112, such as a cathode ray tube (CRT) or LCD display (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computing system 1100 may include a user interface module to implement a GUI that may be stored in a mass storage device as computer executable program instructions that are executed by the computing device(s). Computer system 1100 may further, as described below, implement the techniques described herein using customized hard-wired logic, one or more ASICs or FPGAs, firmware and/or program logic which in combination with the computer system causes or programs computer system 1100 to be a special-purpose machine. According to one implementation, the techniques herein are performed by computer system 1100 in response to processor(s) 1104 executing one or more sequences of one or more computer-readable program instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicated with a WAN). Wireless links may also be implemented. In any such implementation, communication interface 1118 sends and receives electrical, electromagnetic, or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic, or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### Terminology

Processors, such as 202 and 302, may be a whole or part of a computer device or system configured to implement a method, process, function, or operation of at least some of the embodiments described herein. For example, a system or methods may be implemented in the form of an apparatus that includes a processing element and a set of executable instructions. The executable instructions may be part of a software application and arranged into a software architecture.

In general, an embodiment may be implemented using a set of software instructions that are designed to be executed by a suitably programmed processing element (such as a GPU, CPU, microprocessor, processor, controller, computing device, etc.). Such instructions may be arranged into “modules” with each such module typically performing a specific task, process, function, or operation. For example, one module may control supply and flow of a cleaning solution, and another module may operate sensors in water treatment unit 106 or membrane cleaning unit 104. A set of modules may be controlled or coordinated in their operation by an operating system (OS) or other form of organizational platform.

Each application module or sub-module may correspond to a particular function, method, process, or operation that is implemented by execution of the instructions contained in the module or sub-module. Such function, method, process, or operation may include those used to implement one or more aspects, techniques, components, capabilities, steps, or stages of the described system and methods. In some embodiments, a subset of the computer-executable instructions contained in one module may be implemented by a processor in a first apparatus (e.g., a first pump or a second pump in membrane cleaning unit 104), and a second and different subset of the instructions may be implemented by a processor in a second and different apparatus (e.g., managing sensor data read/write operations in water treatment unit 106 or membrane cleaning unit 104). This may happen, for example, where a process or function is implemented by steps that occur in both a water treatment unit or a membrane cleaning unit.

The application modules and/or sub-modules may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method or function described with reference to FIGS. 1-11. These modules may include those illustrated but may also include a greater number or fewer number than those illustrated. As mentioned, each module may contain a set of computer-executable instructions. The set of instructions may be executed by a programmed processor contained in water treatment unit 106 or membrane cleaning unit 104, as well as a server, client device, network element, system, platform, or other component. In other words, processors, such as 202 and 302, need not be contained by water treatment unit 106 or membrane cleaning unit 104.

A module may contain computer-executable instructions that are executed by a processor contained in more than one of a server, client device, network element, system, platform or other component. Thus, in some embodiments, a plurality of electronic processors, with each being part of a separate device, server, platform, or system may be responsible for executing all or a portion of the instructions contained in a specific module.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z.” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed:

1. A system for determining a cleaning strategy for a membrane module, the system comprising:
memory that stores computer-executable instructions; and
a processor in communication with the memory, wherein the computer-executable instructions, when executed by the processor, cause the processor to:
process received operational sensor data and historical cleaning data, wherein the operational sensor data comprises one or more characteristics of a water treatment unit, and wherein the historical cleaning data comprises one or more characteristics of a membrane cleaning unit;
determine, based on the processed operational data, one or more cleaning cycles for a membrane module;
estimate, based on the determined one or more cleaning cycles and the historical cleaning data, a cleaning strategy, wherein the cleaning strategy comprises a sequence of execution of at least one of the one or more cleaning cycles; and
cause the membrane cleaning unit to execute the cleaning strategy to clean the membrane module.

2. The system of claim 1, wherein the computer-executable instructions, when executed, further cause the processor to train an artificial intelligence model using training data to determine one or more cleaning strategies for the membrane module, wherein the training data comprises one or more training data items, wherein each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

3. The system of claim 2, wherein the historical data further comprises at least one of membrane module identification, a historical record of past cleaning strategies, or membrane module performance data based on previously executed cleaning strategies.

4. The system of claim 1, wherein the computer-executable instructions, when executed, further cause the processor to determine one or more cleaning cycles for the membrane module based on forensic fouling analysis data.

5. The system of claim 4, wherein the forensic fouling analysis data comprises at least one of: organic fouling, biological fouling, metallic fouling, inorganic salt scaling, or colloidal particulate fouling data.

6. The system of claim 1, wherein the operational sensor data further comprises at least one of a differential pressure measured across the membrane cleaning unit, a conductivity of the membrane module or process water, a turbidity of the process water, a flow rate of the process water, a current from one or more pumps of the water treatment unit, a discharge pressure from one or more pumps of the water treatment unit, or a detection of one or more chemicals in wastewater.

7. The system of claim 1, wherein the computer-executable instructions, when executed, further cause the processor to determine an intensity for the one or more cleaning cycles, wherein the intensity of a cleaning cycle is associated with one of a duration of the cleaning cycle, a chemical composition of the cleaning cycle, or an energy level provided to one or more cleaning components of the membrane cleaning unit.

8. The system of claim 1, wherein the one or more cleaning cycles comprise at least one of a recirculation cycle, a physical dislodging cycle, a backwashing cycle, or an applied electric field cycle.

9. The system of claim 8, wherein the recirculation cycle applies a chemical solution to the membrane module, wherein the physical dislodging cycle applies a physical force to the membrane module, wherein the backwashing cycle energizes one or more pumps of the membrane cleaning unit to reverse a flow of liquid through a membrane module, and wherein an applied electric field cycle applies an electric field to a membrane module to remove electrically-induced desorption of charged foulants.

10. A computer-implemented method for determining a cleaning strategy for a membrane module, the computer-implemented method comprising:
receiving operational sensor data and historical cleaning data, wherein the operational sensor data comprises one or more characteristics of a water treatment unit, and wherein the historical cleaning data comprises one or more characteristics of a membrane cleaning unit;
determining, based on the operational data, one or more cleaning cycles for a membrane module;
estimating, based on the determined one or more cleaning cycles and the historical cleaning data, a cleaning strategy, wherein the cleaning strategy comprises a sequence of execution of at least one of the one or more cleaning cycles; and
causing the membrane cleaning unit to execute the cleaning strategy to clean the membrane module.

11. The computer-implemented method of claim 10, further comprising training an artificial intelligence model using training data to determine one or more cleaning strategies for the membrane module, wherein the training data comprises one or more training data items, wherein each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

12. The computer-implemented method of claim 11, wherein the historical data further comprises at least one of membrane module identification, a historical record of past cleaning strategies, or membrane module performance data based on previously executed cleaning strategies.

13. The computer-implemented method of claim 10, wherein determining one or more cleaning cycles further comprises determining one or more cleaning cycles for the membrane module based on forensic fouling analysis data.

14. The computer-implemented method of claim 13, wherein the forensic fouling analysis data comprises at least one of: organic fouling, biological fouling, metallic fouling, inorganic salt scaling, or colloidal particulate fouling data.

15. The computer-implemented method of claim 10, wherein the operational sensor data further comprises at least one of a differential pressure measured across the membrane cleaning unit, a conductivity of the membrane module or process water, a turbidity of the process water, a flow rate of the process water, a current from one or more pumps of the water treatment unit, a discharge pressure from one or more pumps of the water treatment unit, or a detection of one or more chemicals in wastewater.

16. The computer-implemented method of claim 10, further comprising determining an intensity for the one or more cleaning cycles, wherein the intensity of a cleaning cycle in the one or more cleaning cycles is associated with one of a duration of the cleaning cycle, a chemical composition of the cleaning cycle, or an energy level provided to one or more cleaning components of the membrane cleaning unit.

17. A non-transitory, computer-readable medium comprising computer-executable instructions for determining a cleaning strategy for a membrane module, wherein the computer-executable instructions, when executed by a computer system, cause the computer system to:
process received operational sensor data and historical cleaning data, wherein the operational sensor data comprises one or more characteristics of a water treatment unit, and wherein the historical cleaning data comprises one or more characteristics of a membrane cleaning unit;
determine, based on the processed operational data, one or more cleaning cycles for a membrane module;
estimate, based on the determined one or more cleaning cycles and the historical cleaning data, a cleaning strategy, wherein the cleaning strategy comprises a sequence of execution of at least one of the one or more cleaning cycle; and
cause the membrane cleaning unit to execute the cleaning strategy to clean the membrane module.

18. The non-transitory, computer-readable medium of claim 17, wherein the computer-executable instructions, when executed, further cause the computer system to train an artificial intelligence model using training data to determine one or more cleaning strategies for the membrane module, wherein the training data comprises one or more training data items, wherein each training data item of the one or more training data items comprises, for an individual second membrane module in a plurality of second membrane modules, at least one of an indication of operational sensor data during operation of the respective second membrane module, forensic fouling analysis for the respective second membrane modules, or historical data for the respective second membrane modules and is labeled with an indication of a sequence of cleaning cycles used to clean the respective second membrane module.

19. The non-transitory, computer-readable medium of claim 18, wherein the historical data further comprises at least one of membrane module identification, a historical record of past cleaning strategies, or membrane module performance data based on previously executed cleaning strategies.

20. The non-transitory, computer-readable medium of claim 19, wherein the computer-executable instructions, when executed, further cause the computer system to determine one or more cleaning cycles for the membrane module based on forensic fouling analysis data.
